(19) United States
(12) Patent Application Publication
(10) Pub. No.: US 2020/0347850 A1
(43) Pub. Date: Nov. 5, 2020

(54) FLOW-MODIFYING DEVICE FOR COMPRESSORS

(71) Applicant: BorgWarner Inc., Auburn Hills, MI (US)

(72) Inventors: Tom HEUER, Jakobsweiler (DE); Sascha KARSTADT, Undenheim (DE); Thomas LISCHER, St.Martin (DE); Johannes BUEHLER, Ottersweier (DE); Sebastian LEICHTFUSS, Darmstadt (DE)

(21) Appl. No.: 16/862,802

(22) Filed: Apr. 30, 2020

(30) Foreign Application Priority Data
Apr. 30, 2019 (EP) 19171814.7

(51) Int. Cl. F04D 27/00; F04D 27/02

(52) U.S. Cl. CPC F04D 27/003; F05D 2260/60; F04D 27/0253

(57) ABSTRACT

The present invention relates to a flow-modifying device for a compressor of a charging apparatus. The flow-modifying device comprises a cylindrical housing portion, which defines an inner lateral surface and in the axial direction comprises a downstream end region and an upstream end region. The flow-modifying device furthermore comprises a plurality of pockets, which are arranged on the inner lateral surface, spaced-apart from one another in the peripheral direction. Each pocket is defined here by a longitudinal projection line and a depth projection line. In an orientation plane, which is formed by the longitudinal projection line and the depth projection line, there is arranged a downstream angle of entry α of the pocket relative to the inner lateral surface and an upstream angle of entry β of the pocket relative to the inner lateral surface. The downstream angle of entry α defines a downstream opening region of the pocket and the upstream angle of entry β defines an upstream opening region of the pocket. The pocket is formed here in such a way that: β<90°<α.

### CROSS-REFERENCE TO RELATED APPLICATIONS

This application claims the benefit of European Patent Application No. 19171814.7 filed Apr. 30, 2019, the disclosure of which is herein incorporated by reference in its entirety.

### TECHNICAL FIELD

The present invention relates to a flow-modifying device for a compressor of a charging apparatus. The invention also relates to a compressor and a charging apparatus comprising a flow-modifying device of this kind.

### BACKGROUND

Newer generation vehicles are being equipped increasingly with charging apparatuses in order to overcome the challenges encountered and to satisfy legal stipulations. When developing a charging apparatus, the objective is to optimize the reliability and efficiency of both the individual components as well as the system as a whole.

Known charging apparatuses usually have at least one compressor with a compressor wheel, which is connected to a drive unit via a common shaft. The compressor compresses the fresh air drawn in for the internal combustion engine or for the fuel cell. The volume of air or oxygen that is available to the engine for combustion or the fuel cell for reaction is thus increased. This leads in turn to a performance increase of the internal combustion engine or the fuel cell. Charging apparatuses may be equipped with different drive units. In the prior art, E-chargers in particular, in which case the compressor is driven via an electric motor, and turbochargers, in which case the compressor is driven via an exhaust gas turbine, are known. Combinations of both systems are also described in the prior art.

Each compressor has a compressor-specific characteristic map, with the operation of the compressor being limited to the region of the compressor characteristic map between the surge line and the choke line. In the compressor characteristic map the throughput volume flow on the abscissa is plotted against the pressure ratio between compressor inlet and output on the ordinate. Furthermore, curved lines are plotted for different speeds up to a maximum permissible speed between the surge line and the choke line. Depending on the size and design of the compressor, operation with low volume flows through the compressor may be inefficient or might no longer be possible dependably, since the surge line is reached. This means that the pump line limits the compressor characteristic map to the left, the choke line to the right.

Various measures are known in the prior art to optimize the compressor characteristic map. In particular, these are adjustment mechanisms, which are arranged in the inlet region of the compressor before the compressor wheel in the flow direction, and machined housing adaptations in the compressor inlet wall for flow modification. The flow cross-section in the compressor inlet can be varied by the adjustment mechanisms, whereby for example the incoming flow and the volume flow can be matched to the compressor wheel. The machined adaptations in the compressor inlet wall include in particular what are known “ported shrouds” (for example recirculation channels). Both types of flow-modifying devices act as a characteristic map-extending or characteristic map-stabilizing measure, whereby again a surging of the compressor at engine-relevant operating points can be reduced or avoided.

The object of the present invention is to provide an improved flow-modifying device for characteristic map stabilization or a compressor having an improved compressor characteristic map.

### SUMMARY OF THE INVENTION

The present invention relates to a flow-modifying device for a compressor of a charging apparatus according to claim 1. The invention also relates to a compressor and a charging apparatus comprising a flow-modifying device of this kind according to claims 10 and 15 respectively.

The flow-modifying device for a compressor of a charging apparatus comprises a cylindrical housing portion and a plurality of pockets. The cylindrical housing portion defines an inner lateral surface. The cylindrical housing portion also comprises a downstream end region in the axial direction and an upstream end region in the axial direction. In this case the upstream end region is arranged opposite the downstream end region in the axial direction. The pockets are arranged on the inner lateral surface, spaced-apart from one another in the peripheral direction. In this case each pocket is defined by a longitudinal projection line and a depth projection line. In an orientation plane, which is formed by the longitudinal projection line and the depth projection line, a downstream opening region of the pocket is defined by a downstream angle of entry α of the pocket relative to the inner lateral surface. Likewise in the orientation plane, which is formed by the longitudinal projection line and the depth projection line, an upstream opening region of the pocket is defined by an upstream angle of entry β of the pocket relative to the inner lateral surface. The pockets are formed here in such a way that: β<90°<α. Due to this specific embodiment of the pocket, fluids can flow in a simplified manner via the downstream opening region into the pocket toward the upstream opening region, in which the fluids can be conducted through the upstream angle of entry β back in the direction of the downstream end region. An embodiment of this kind of the flow-modifying device, if used in a compressor, can result in a significant improvement of the characteristic map stability. In particular, both the lower and the upper characteristic map region can be stabilized. Compared to a “ported shroud” known from the prior art, the efficacy can be seen already at lower pressure ratios. If the flow-modifying device is used in a compressor for an internal combustion engine, the specific embodiment of the flow-modifying device with the pockets enables a noticeable shift of the operating points close to the surge line toward smaller throughputs (or toward higher pressure with constant throughput). As a result, an earlier and higher torque can be provided at the internal combustion engine. Manufacturing advantages are also provided, for example as compared to a “ported shroud”, with which additional parts are necessary, for example a core for the recirculation cavity, which by contrast can be spared in the case of the present flow-modifying device.

In some embodiments of the flow-modifying device, the pocket may be formed in such a way that: β<180°−α. As a result of this embodiment, a steeper return flow from the pocket in the direction of the downstream end region can be provided. In alternative embodiments the pocket may also be formed in such a way that β=180°−α or β>180°−α. In particular the latter embodiment may lead to simplifications of the manufacturing process.

In some embodiments of the flow-modifying device which are combinable with the previous embodiment, the pocket may be formed so that 10°<β<30°, preferably 15°<β<20° and particularly preferably 17°≤β≤19°.

In some embodiments of the flow-modifying device which are combinable with any of the previous embodiments, the pocket may be formed so that 120°<α<165°, preferably 130°<α<150° and particularly preferably 135°≤α≤145°.

In some embodiments of the flow-modifying device which are combinable with any of the previous embodiments, the depth projection line may be inclined relative to the radial direction by an angle of attack γ. In addition, the pocket may be formed so that 0°<γ<60°, preferably 15°<γ<50° and particularly preferably 35°≤γ≤45°. In particular, the angle of attack γ in this case may be angled from the radial direction in a rotation direction of a compressor wheel. This advantageous embodiment leads to an improved fluid flow into the pocket. A greater volume flow hereby may be recirculated in turn back through the pocket in the direction of the downstream end region. With use of the flow-modifying device in a compressor, a greater volume flow may thus be conducted back to the compressor wheel, whereby in turn the efficiency may be increased.

In some embodiments of the flow-modifying device which are combinable with any of the previous embodiments, a width of the pocket orthogonally to the orientation plane may be 1 mm×F_{D} to 6 mm×F_{D}, preferably 2 mm×F_{D} to 5 mm×F_{D} and particularly preferably 3 mm×F_{D} to 4 mm×F_{D}. In this case, F_{D}=D/D_{Ref}, with D_{Ref} preferably being 60 mm and D corresponding to an outlet diameter of a compressor wheel of the compressor for which the flow-modifying device is designed. In other words, this means that the dimensions of the pocket, in particular the width of the pocket, are configured depending on the dimensions of the compressor wheel for the operation of which the flow-modifying device is designed or together with which the flow-modifying device will be used.

In some embodiments of the flow-modifying device which are combinable with any of the previous embodiments, a length of the pocket along the longitudinal projection line may be 5 mm×F_{D} to 30 mm×F_{D}, preferably 10 mm×F_{D} to 25 mm×F_{D} and particularly preferably 15 mm×F_{D} to 20 mm×F_{D}. In this case, F_{D}=D/D_{Ref}, with D_{Ref} preferably being 60 mm and D corresponding to an outlet diameter of a compressor wheel of the compressor for which the flow-modifying device is designed. In other words, this means that the dimensions of the pocket, in particular the width of the pocket, are configured depending on the dimensions of the compressor wheel for the operation of which the flow-modifying device is designed or together with which the flow-modifying device will be used.

In some embodiments of the flow-modifying device which are combinable with any of the previous embodiments, a depth of the pocket along the depth projection line may be 5 mm×F_{D} to 30 mm×F_{D}, preferably 10 mm×F_{D} to 25 mm×F_{D} and particularly preferably 15 mm×F_{D} to 20 mm×F_{D}. In this case, F_{D}=D/D_{Ref}, with D_{Ref} preferably being 60 mm and D corresponding to an outlet diameter of a compressor wheel of the compressor for which the flow-modifying device is designed. In other words, this means that the dimensions of the pocket, in particular the width of the pocket, are configured depending on the dimensions of the compressor wheel for the operation of which the flow-modifying device is designed or together with which the flow-modifying device will be used.

In some embodiments of the flow-modifying device which are combinable with any of the previous embodiments, the longitudinal projection line may be inclined relative to the axial direction by a tilt angle δ. In addition, the pocket may be designed so that 0°<δ<60°, preferably 5°<δ<45°, and particularly preferably 10°≤δ≤30°.

In some embodiments of the flow-modifying device which are combinable with any of the previous embodiments, the pocket may comprise an opening with an opening face. In addition, the opening may comprise an opening length. The opening length may extend along the longitudinal projection line and may be 2 mm×F_{D} to 25 mm×F_{D}, preferably 5 mm×F_{D} to 20 mm×F_{D} and particularly preferably 10 mm×F_{D} to 15 mm×F_{D}. In this case, the factor F_{D}=D/D_{Ref}, with D_{Ref} preferably being 60 mm and D corresponding to an outlet diameter of a compressor wheel of the compressor for which the flow-modifying device is designed. In other words, this means that the dimensions of the pocket, in particular the opening length of the pocket, is configured depending on the dimensions of the compressor wheel for the operation of which the flow-modifying device is designed or together with which the flow-modifying device will be used. Alternatively or additionally the longitudinal projection line may lie in a plane that is defined by the opening face.

In some embodiments of the flow-modifying device which are combinable with any of the previous embodiments, the longitudinal projection line may run centrally through the pocket as considered in the peripheral direction. The longitudinal projection line may optionally run centrally through the pocket as considered in the peripheral direction, between the downstream opening region and the upstream opening region. In other words, this means that the longitudinal projection line is a kind of central line in the longitudinal orientation of the pocket. The word “centrally” thus shall be understood here to mean a center as considered in the peripheral direction. The course of the longitudinal projection line in this case runs along the longitudinal extent of the pocket. In other words, the longitudinal projection line runs from the downstream end region to the upstream end region. The longitudinal projection line also runs partially over the inner lateral surface.

In some embodiments of the flow-modifying device which are combinable with any of the previous embodiments, the depth projection line may run centrally through the pocket as considered in the peripheral direction. In other words, this means that the depth projection line is a kind of center line in the depth orientation of the pocket. The word “centrally” thus shall be understood here to mean a center as considered in the peripheral direction.

In some embodiments of the flow-modifying device which are combinable with any of the previous embodiments, the pocket may comprise a length, an opening with an opening length, and a depth.

In some embodiments of the flow-modifying device which are combinable with any of the previous embodiments, a contour of the pocket may be defined by an entry point at which the downstream angle of entry α is present, by an exit point at which the upstream angle of entry β is present, and by a change point between the entry point and the exit point. In addition, the contour may lie in the orientation plane. This means that the contour is a kind of contour line of the pocket in a section in the orientation plane.

Alternatively or additionally to the previous embodiment, the entry points may be determined by a downstream point of intersection between the longitudinal projection line and an opening contour of the opening. The exit point may be determined by an upstream point of intersection between the longitudinal projection line and the opening contour. The change point may represent the deepest point of the contour relative to the longitudinal projection line. This means that the change point may be considered to be the deepest point of the contour. This means a point in the depth of the pocket at the point of intersection with the depth projection line.

Alternatively or additionally to the previous embodiment, a first contour portion with a variable angle α′ may be formed between the entry point and the change point. A second contour portion with a variable angle β′ may be formed between the change point and the exit point. The variable angles α′ and β′ are considered relative to the lateral inner surface. This means that the variable angles α′ and β′ are considered analogously to the downstream entry angle α and to the upstream entry angle β. Alternatively, the variable angles α′ and β′ are also considered analogously relative to a parallel of the longitudinal projection line at the depth of the pocket according to the Z angle.

In addition to the previous embodiment, the variable angle α′ may change from α′=α at the entry point to α′=180° at the change point, in such a way that the profile of the first contour portion from the entry point to the change point does not have any sudden changes or kinks, and the variable angle α′ at least does not become smaller. In other words, the profile of the first contour portion may be defined as differentiable, and alternatively or additionally the variable angle α′ in its course from the entry point to the change point at least does not become smaller.

Alternatively or additionally to the previous embodiment, the variable angle β′ may change from β′=180° at the change point to β′=β at the exit point, in such a way that the profile of the second contour portion from the change point to the exit point does not have any sudden changes or kinks, and the variable angle β′ at least does not become larger. In other words, the profile of the second contour portion may be defined as differentiable, and alternatively or additionally the variable angle β′ in its course from the change point to the exit point at least does not become larger.

Alternatively or additionally to any of the two previous embodiments, the contour may have a turning point between the change point and the exit point. In other words, the second contour portion may have a turning point. The turning point may be arranged between the change point and the exit point. The turning point may define a maximum length of the pocket. The turning point may thus be defined in that, for the variable angle β′:β′=90°. In other words, the turning point may be defined in that the variable angle β′ over its course from the change point to the exit point reaches a value of β′=90° for the first time.

In some embodiments of the flow-modifying device which are combinable with the previous embodiment, the pockets may be arranged equidistantly in the peripheral direction. In alternative embodiments, the pockets may also be arranged at irregular distances in the peripheral direction. Furthermore, one or more of the pockets may also be formed differently as compared to the other pockets. In particular, one or more of the dimensions of one or more pockets, that is to say a width and/or a length and/or a depth and/or an opening with an opening length may be different as compared to one or more of the dimensions of the other pockets. The flow-modifying device may also have different numbers of pockets.

The invention also relates to a compressor for a charging apparatus. The compressor comprises a compressor housing, a compressor wheel, and a flow-modifying device according to any one of the previous embodiments. The compressor housing defines a compressor inlet with an inlet cross-section and a compressor outlet. The compressor wheel is arranged between the compressor inlet and the compressor outlet so as to be rotatable in the compressor housing. As already mentioned further above, by use of the flow-modifying device in a compressor, a significant improvement of the characteristic map stability may be achieved. In particular, both the lower and the upper characteristic map region may be stabilized. Compared to a “ported shroud” known from the prior art, the efficacy can be seen already at lower pressure ratios. If the compressor is used for an internal combustion engine, the specific embodiment of the flow-modifying device with the pockets enables a noticeable shift of the operating points close to the surge line toward smaller throughputs (or toward higher pressure with constant throughput). As a result, an earlier and higher torque can be provided at the internal combustion engine. The flow-modifying device may be introduced here as a retrofit measure into existing parts by means of machining. Different customer applications may hereby be covered by identical unmachined parts. This results in manufacturing and financial advantages due to a high degree of part standardization.

In some embodiments of the compressor, the compressor may also comprise an adjustment mechanism having a plurality of aperture elements for changing the inlet cross-section. Due to the combined use of the flow-modifying device with the adjustment mechanism, a further improvement of the characteristic map stability, both in the lower and in the upper characteristic map region, may be achieved. In particular, the adjustment mechanism may be actuated in this case between a first, open position and a second, closed position. The inlet cross-section is unchanged in the first position. By contrast, the inlet cross-section is reduced in the second position. In particular with a low volume flow and/or low pressure ratios, the compressor characteristic map may be optimized by the adjustment mechanism by moving the adjustment mechanism into the second position. There are thus two different characteristic map regions in the two different positions of the adjustment mechanism, which map regions are separated from one another in a boundary region by a gap. Due to the combination with the specific embodiment of the flow-modifying device, this gap between the characteristic map regions can be reduced. As a result of this surprising effect with a combined use of the adjustment mechanism with the flow-modifying device, a significantly improved compressor with an improved compressor characteristic map in both positions of the adjustment mechanism can be provided.

In some embodiments of the compressor which are combinable with the previous embodiment, the cylindrical housing portion may be arranged downstream of the aperture elements.

In some embodiments of the compressor which are combinable with the two previous embodiments, the cylindrical housing portion may be configured as a bearing ring for the aperture elements. A separate pre-manufacturable module for use in the compressor may hereby be provided. Furthermore, the compressor or the combination of adjustment mechanism and flow-modifying device may thus be made more compact.

In some embodiments of the compressor which are combinable with any of the previous embodiments, the cylindrical housing portion may be manufactured integrally with the compressor housing. Alternatively, the cylindrical housing portion may be manufactured as a separate component. If the cylindrical housing portion is manufactured as a separate component, the cylindrical housing portion may be insertable into the compressor housing from the compressor inlet in the axial direction to the compressor outlet or from the compressor outlet in the axial direction to the compressor inlet, that is to say in the opposite direction. In particular if the cylindrical housing portion is insertable into the compressor housing from the compressor outlet in the axial direction to the compressor inlet, a compressor contour may be formed by the cylindrical housing portion. Since this compressor contour is formed at the separate cylindrical housing portion, the geometry/surface of the compressor contour is more flexible and more easily accessible for exact machining. Due to an integral manufacture of the cylindrical housing portion with the compressor housing, the flow-modifying device may be integrated into existing compressor geometries. If the cylindrical housing portion is formed as a separate component, identical compressor housings, into which flow-modifying devices of different designs are insertable, may be used for different compressor applications as appropriate. Furthermore, advantages in respect of the manufacturing process and/or used material may be provided in some circumstances if the cylindrical housing portion is formed as a separate component. On the whole, manufacturing and financial advantages may be provided as a result of these embodiments due to a high degree of part standardization.

In some embodiments of the compressor which are combinable with any of the previous embodiments, the cylindrical housing portion may be constructed in a number of parts. In particular, the cylindrical housing portion may comprise a plurality of sub-portions in the peripheral direction. Alternatively or additionally, the cylindrical housing portion may comprise a plurality of sub-portions in the axial direction.

In some embodiments of the compressor which are combinable with the previous embodiment, the cylindrical housing portion may consist of a first sub-portion in the axial direction and a second sub-portion in the axial direction. The first and the second sub-portion are formed in this case in particular annularly. The first and the second sub-portion may separate the pockets at their deepest point. In other words, this means that the first and the second sub-portion divide the pockets at the change point. This has manufacturing advantages in particular. In addition, one of the first or second sub-portion may be manufactured integrally with the compressor housing. Alternatively or additionally, the other of the first or second sub-portion may be insertable into the compressor housing from the compressor inlet in the axial direction to the compressor outlet or from the compressor outlet in the axial direction to the compressor inlet. In particular if the cylindrical housing portion is insertable into the compressor housing from the compressor outlet in the axial direction to the compressor inlet, a compressor contour may be formed by the cylindrical housing portion. Since this compressor contour is formed at the separate cylindrical housing portion, the geometry/surface of the compressor contour is more flexible and more easily accessible for exact machining.

In some embodiments of the invention which are combinable with any of the previous embodiments, the cylindrical housing portion, if this is formed as a separate part, may be connected to the compressor housing by a press fit, a snap fit connection, a screwed connection or another suitable coupling technology. This is also true similarly for embodiments in which individual or all sub-portions (if provided), and not the entire housing portion, are manufactured separately.

In some embodiments of the compressor which are combinable with any one of the previous embodiments, the cylindrical housing portion, if this is formed as a separate part, may be produced from plastic. The cylindrical housing portion may optionally have an overdimension in the direction of the compressor wheel, which overdimension can be reduced, in particular can be ground down, by the compressor wheel during operation of the compressor. In particular, a contour region of the compressor, that is to say the aforementioned compressor contour, may have an overdimension as the housing portion is inserted from the compressor outlet in the axial direction to the compressor inlet and may be ground down by the compressor wheel. This results advantageously in a reduced necessary manufacturing tolerance. In turn, manufacturing costs may thus be reduced, and the entire manufacturing process is simplified.

In some embodiments of the compressor which are combinable with any of the previous embodiments, the compressor wheel may comprise a plurality of blades distributed in the peripheral direction. Each blade has a leading-edge, a side edge, a trailing edge, a front side and a rear side. In addition, the pockets may be arranged in the axial direction in such a way that the opening of each pockets is situated both upstream and downstream of a vertex at which the leading edge and the side edge converge. In addition, the pockets may be arranged in the axial direction in such a way that a center of the opening which lies halfway along the opening length is situated approximately at the aforesaid vertex. In alternative embodiments, other arrangements are also possible. For example, a ratio between a downstream opening length, which is arranged downstream of the vertex, and an upstream opening length, which is arranged upstream of the vertex, it is also greater than or smaller than 1.

In some embodiments of the compressor which are combinable with any of the preceding embodiments, the angle of attack γ may be angled from the radial direction in a rotation direction ω of the compressor wheel. This advantageous embodiment leads to an improved fluid flow into the pocket. A greater volume flow may hereby be conducted or recirculated in turn back through the pocket in the direction of the downstream end region, that is to say back to the compressor wheel, whereby in turn the efficiency may be increased.

The invention also relates to a charging apparatus. The charging apparatus comprises a compressor according to any of the previous embodiments. The charging apparatus also comprises a shaft, via which the compressor and the drive unit are coupled to one another for conjoint rotation. The drive device may comprise a turbine and/or electric motor.

The invention also comprises a method for producing a compressor according to any of the previous embodiments. The pockets are produced here in the housing portion by a milling process, an erosion process, a casting process, or a combination of a number of production processes. A number of basic shapes are particularly preferably provided for the various pockets in the cylindrical housing portion by means of a casting process and the subsequent milling out of the pockets.

### BRIEF DESCRIPTION OF THE DRAWINGS

FIG. 1A shows a sectional view of the flow-modifying device along the section A-A from FIG. 1B;

FIG. 1B shows a sectional view of the flow-modifying device along the section B-B from FIG. 1A;

FIGS. 2A-2C show three different side views of a multiview projection of the geometry of the pocket;

FIG. 3A shows a detail of FIG. 1A, from which the angle of attack γ can be inferred;

FIG. 3B shows the arrangement of the tilt angle δ of a pocket relative to the axial direction;

FIG. 4 shows a detailed view of the pocket from FIG. 2A to illustrate the contour of the pocket;

FIG. 5 shows the compressor with compressor wheel and the flow-modifying device in a side sectional view along the section C-C from FIG. 1A and a detail Y of the pocket through a section along the orientation plane of the pocket;

FIG. 6 shows the compressor with compressor wheel, and the flow-modifying device in a view analogous to FIG. 5, additionally comprising an adjustment mechanism and a detailed view Z of the pocket;

FIGS. 7A-7B show a comparison of compressor characteristic maps of a compressor only with adjustment mechanism and a compressor with adjustment mechanism and the flow-modifying device for the open and closed positions of the adjustment mechanism;

FIG. 8A shows the cylindrical housing portion of the flow-modifying device in heavily simplified form in an integral design with the compressor housing;

FIGS. 8B-8C show the cylindrical housing portion of the flow-modifying device in heavily simplified form as a separate component inserted downstream in the axial direction and inserted upstream in the axial direction;

FIGS. 9A-9D show different embodiments of a cylindrical housing portion of the flow-modifying device constructed in a number of parts in the axial direction in heavily simplified form in a compressor;

FIGS. 10A-10D show schematic views of various fastening variants of the cylindrical housing portion of the flow-modifying device in heavily simplified form as a separate component;

FIGS. 11A-11B show a cylindrical housing portion of the flow-modifying device constructed in one part in the peripheral direction and a cylindrical housing portion of the flow-modifying device constructed in a number of parts in the peripheral direction, in heavily simplified form in a compressor housing;

FIGS. 12A-12D show different embodiments and arrangements of the pockets in the cylindrical housing portion;

FIGS. 13A-13E show schematic illustrations of different methods for producing the pockets in the cylindrical housing portion;

FIG. 14 shows a schematic illustration of a charging apparatus with flow-modifying device shown in simplified form and adjustment mechanism shown in simplified form.

### DETAILED DESCRIPTION

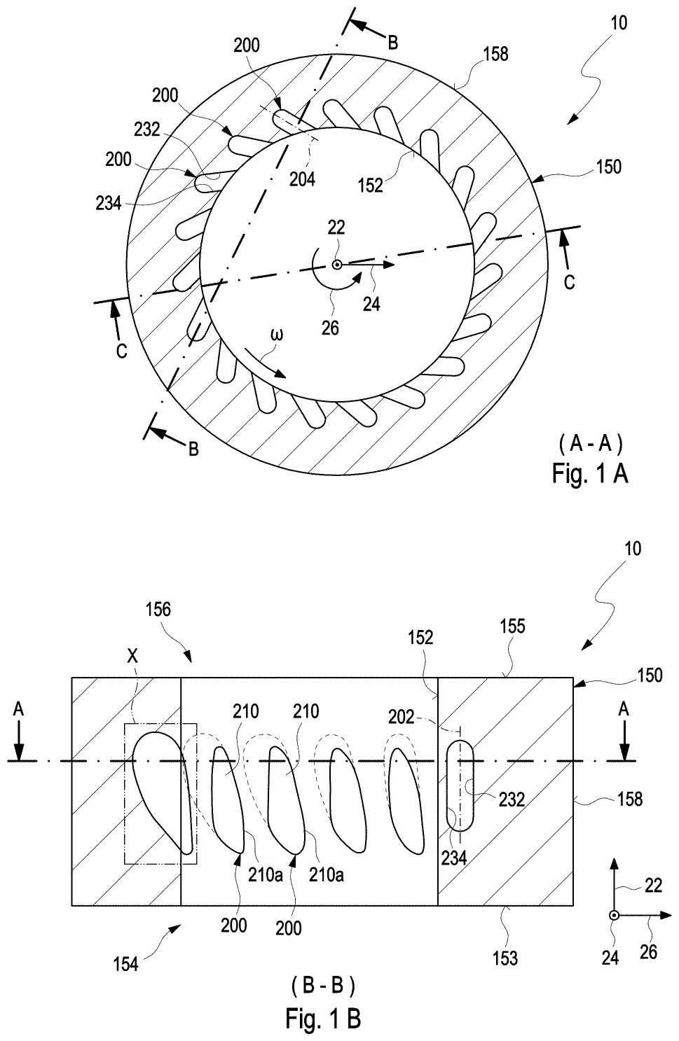

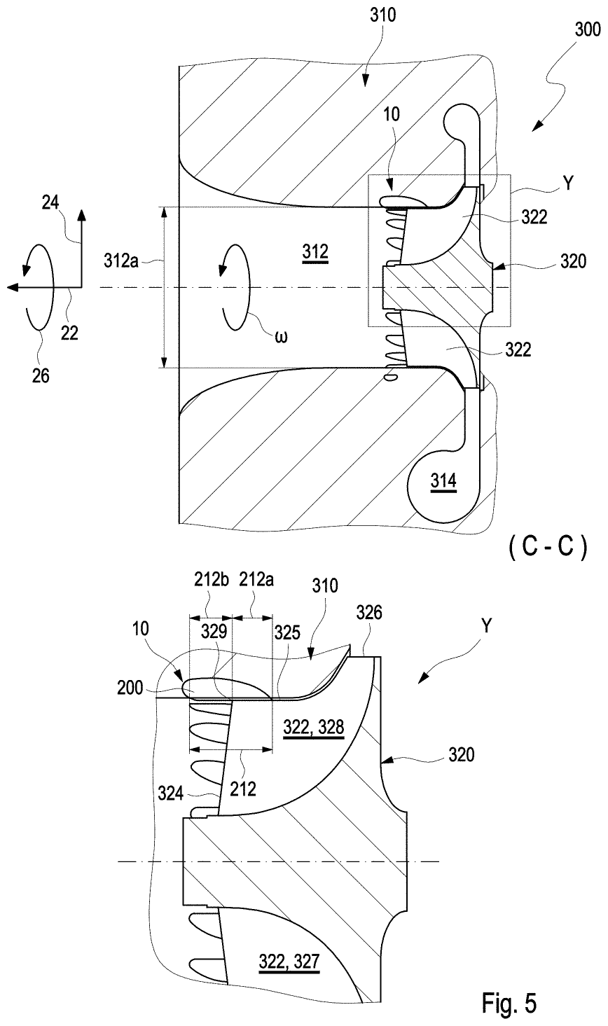

In the context of this application, the terms “axially” and “axial direction” refer to an axis of the flow-modifying device, that is to say to a cylinder axis of the cylindrical housing portion or to a rotation axis of the compressor or the compressor wheel. With reference to the drawings (for example see FIGS. 1A-1B or FIG. 5) the axial direction of the flow-modifying device or compressor is shown by reference numeral 22. A radial direction 24 is based here on the axis 22 of the flow-modifying device or the compressor. A periphery or a peripheral direction 26 is also based here on the axis 22 of the flow-modifying device or the compressor. Furthermore, the term “downstream” is based on a substantially axial direction 22 from one end region of the flow-modifying device (more precisely: upstream end region) to another end region of the flow-modifying device (more precisely: downstream end region). The term “upstream” is based on a direction substantially opposite the downstream direction. Based on the compressor, the terms “downstream” and “upstream” art to be considered analogously, that is to say as substantially axial directions (22), which are directed toward a compressor wheel of the compressor or away therefrom, starting from the compressor inlet.

FIGS. 1A and 1B show the flow-modifying device 10 according to the invention for a compressor 100 of a charging apparatus 400. The flow-modifying device 10 comprises a cylindrical housing portion 150 and a plurality of pockets 200, which can be clearly seen in the sectional view of FIG. 1A. The cylindrical housing portion 150 defines an inner lateral surface 152 and an outer lateral surface 158. The cylindrical housing portion 150 furthermore comprises a downstream end region 154 in the axial direction 22 and an upstream end region 156 in the axial direction 22. The upstream end region 156 is arranged opposite the downstream end region 154 in the axial direction 22. The downstream end region 154 terminates in the axial direction 22 by a downstream end face 153. The upstream end region 156 terminates in the axial direction 22 by an upstream end face 155. The pockets 200 are arranged on the inner lateral surface 152, spaced apart from one another in the peripheral direction 26. Here, FIG. 1B shows how the pockets 200 are arranged on the inner lateral surface 152 along the section B-B from FIG. 1A. In this case, the opening 210 of a pocket 200 and the corresponding opening contour 210a can be seen. The profile of the particular pocket 200, which results from the pocket 200 in question having a specific geometry and being arranged in a specific orientation relative to the cylindrical housing portion 150 or in a lateral surface 152 thereof (for example see FIG. 1A), is shown by means of a dashed line and adjoins the opening contour 210a of the pocket 200 in question.

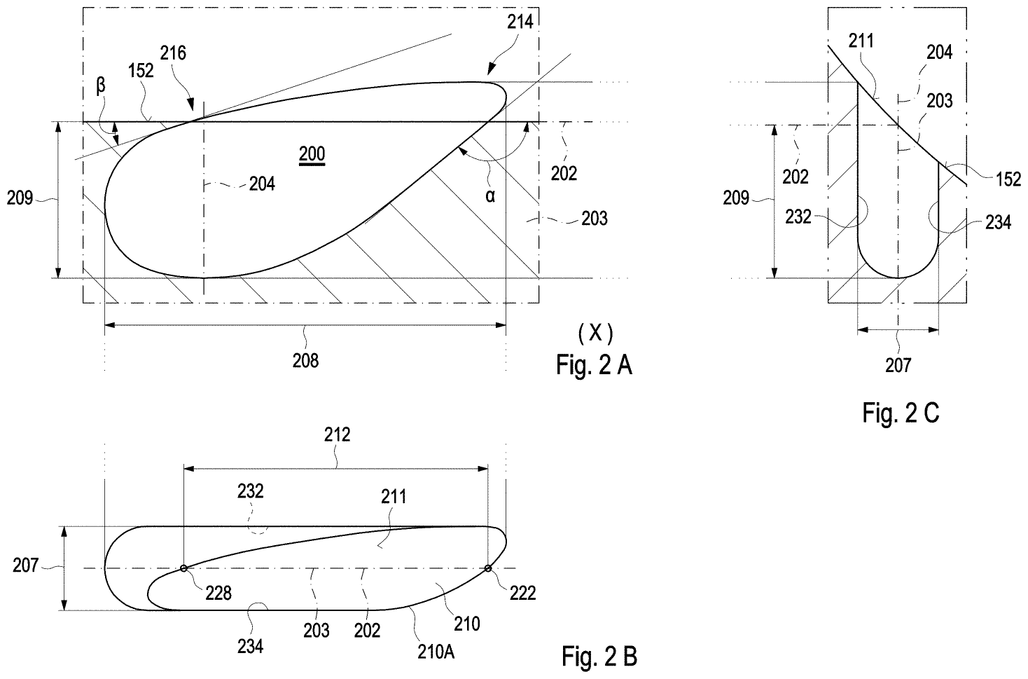

In order to define the geometry of a pocket 200 more precisely, a longitudinal projection line 202 and a depth projection line 204 for a pocket 200 may be introduced (see FIGS. 2A-2C). By way of example, the pocket geometry will be explained hereinafter on the basis of a pocket 200. However, this should be understood to be analogous for all pockets 200. In this regard, a section through the pocket 200 in an orientation plane 203 is shown in FIG. 2A. In order to simplify the understanding, it should be noted that FIG. 2A corresponds to the detail X from FIG. 1A. This means that the section B-B runs exactly along the orientation plane 203 of the pocket 200 from the detail X. With reference to FIG. 2A it can be seen that the pocket 200 has a downstream opening region 214 and an upstream opening region 216. The downstream opening region 214 is defined here by a downstream entry angle α of the pocket 200 relative to the lateral inner surface 152. The upstream opening region 216 is defined here by an upstream entry angle β of the pocket 200 relative to the lateral inner surface 152. The expression “relative to the lateral inner surface 152” shall be understood here to mean relative to the solid material of the lateral inner surface 152. Both the downstream entry angle α and the upstream entry angle β lie here in the orientation plane 203 (see FIG. 2A). The pocket 200 is formed here in such a way that: β<90°<α.

As a result of this specific embodiment of the pocket 200, fluids, in particular fluids flowing back, may flow in simplified fashion via the downstream opening region 214 into the pocket 200 and towards the upstream opening region 216, in which the fluids may then be conducted back in the direction of the downstream end region by the upstream entry angle β. In other words, fluids flowing back may be deflected effectively in the downstream direction. An embodiment of this kind of the flow-modifying device 10, if used in a compressor 300, may result in a significant improvement of the characteristic map stability. In particular, both the lower and the upper characteristic map region may be stabilized. Compared to a “ported shroud” known from the prior art, the efficacy is evident already at lower pressure ratios. If the flow-modifying device 10 is used in a compressor 300 for an internal combustion engine, the specific embodiment of the flow-modifying device 10 with the pockets 200 enables a significant shift of the operating points in the vicinity of the surge line toward smaller throughputs (or toward higher pressure with constant throughput). An earlier and higher torque may hereby be provided at the internal combustion engine. Manufacturing advantages are also provided, for example as compared to a “ported shroud”, with which additional parts are necessary, for example a core for the recirculation cavity, which by contrast can be spared in the case of the present flow-modifying device 10 due to the specific embodiment with pockets 200.

As can be seen in FIG. 2B, the longitudinal projection line 202 runs centrally through the pocket 200 as considered in the peripheral direction 26 quick. In other words, this means that the longitudinal projection line 202 runs or is oriented centrally through the pocket 200 as considered in the peripheral direction 26, between the downstream opening region 214 and the upstream opening region 216. This means that the longitudinal projection line 202 shall be understood to be a kind of central line in the longitudinal orientation of the pocket 200. The word “centrally” thus shall be understood here to mean a center as considered in the peripheral direction 26. In this regard, a first side wall 232 and a second side wall 234 can also be seen in FIGS. 1A, 1B, 2B and 2C each have a pocket 200. For reasons of clarity, the side walls 232, 234 have been shown from the outside of the pockets 200, although they are actually formed from the inside of the pockets 200 towards the cylindrical housing portion 150. In particular, it can be clearly seen from FIG. 2B that the longitudinal projection line 202 extends centrally between the first side wall 232 and the second side wall 234. The course of the longitudinal projection line 202 is by contrast along the longitudinal extent of the pocket 200. In other words, the longitudinal projection line 202 is oriented from the downstream end region 154 to the upstream end region 156. However, this is only true if the following applies for the tilt angle δ explained further below: δ=0°. The longitudinal projection line 202 runs in a plane of the inner lateral surface 152. This is clearly visible in particular in FIGS. 2A and 2B, in which it can be seen that the longitudinal projection line 202 in the right-hand part of the shown pocket 200, runs in a plane of the inner lateral surface 152 or the opening 210 of the pocket 200. The opening 210 has an opening face 211. This opening face 211 is delimited by the opening contour 210a. The opening face 211 in this case lies in the same plane, in particular in a curved plane, as the inner lateral surface 152 (shown in FIG. 2B). This means that the opening face 211 lies in a lateral plane of the inner lateral surface. This means that the opening face 211 has a curvature or arch. For the longitudinal projection line 202, this means that it lies, in the right-hand part of the shown pocket 200, over the opening face 211. In other words, the longitudinal projection line 202 lies in a plane that is defined by the opening face 211. In the left-hand part of the shown pocket 200, the longitudinal projection line 202 runs at least partially also directly over the lateral inner surface 152. Similarly, the depth projection line 204 can also be seen, which likewise runs centrally through the pocket 200 as considered in the peripheral direction 26. This means that the depth projection line 204 is a kind of center line in the depth orientation of the pocket 200. Here, the depth orientation may be understood to mean an orientation of the pocket 200 that runs starting from the opening 210, centrally between the side walls 232, 234, starting from the inner lateral surface 152, into the material of the cylindrical housing portion 150 to the deepest point of the pocket 200 (see FIGS. 2A and 2C). The word “centrally” is thus understood here to mean a center as considered in the peripheral direction 26. In principle, the longitudinal projection line 202 and the depth projection line 204 shall be understood here to mean relative orientation lines of the pocket 200, which each run centrally between the side walls 232, 234 of the pocket 200. For this reason, the longitudinal projection line 202 and the depth projection line 204 our shown as dot-and-dash lines in the various views shown in the drawings. In this regard, reference should also be made to FIG. 1A and FIG. 1B, in which the depth projection line 204 or the longitudinal projection line 202 are shown by way of example for a pocket 200 (see the pocket 200 furthest to the right in the section B-B).

As can also be inferred from FIG. 2A, the pocket 200 is formed in such a way that the following is true: β<180°−α. As a result of this embodiment, a steeper return flow from the pocket 200 in the direction of the downstream end region 154 may be provided. However, in alternative embodiments, the pocket 200 may also be formed in such a way that: β=180°−α or β>180°−α. In particular, the latter embodiment may lead to simplifications of the manufacturing process, since the undercut at the upstream entry angle β, that is to say in the upstream opening region 216, in some circumstances can be produced more easily. In the example of FIG. 2A, the pocket 200 is formed with an upstream entry angle β of approximately 17°≤β≤19°, and with a downstream entry angle α of approximately 135°≤α≤145°. This means that the upstream entry angle β and the downstream entry angle α are exact values from their respective ranges. In principle, however, other values may be selected for the entry angles α and β in alternative embodiments. For example, the upstream entry angle β may also assume a value in the range of 10°<β<30°, preferably in the range of 15°<β<20°. The downstream entry angle α may also assume a value in the range of 120°<α<165°, preferably in the range of 130°<α<150°.

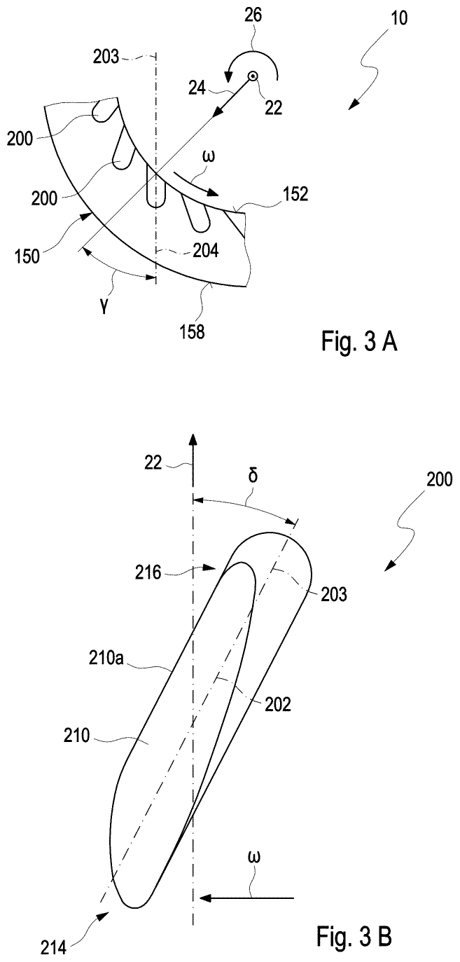

As has already been seen in FIG. 1A and as is shown in detail in FIG. 3A, the depth projection line 204 is inclined relative to the radial direction 24 by and angle of attack γ. This angle of attack γ particularly preferably has a value from 35°≤γ≤45°. Alternatively, the pocket may also be formed so that, for the angle of attack γ, 0°<γ<60° and preferably 15°<γ<50°. If the flow-modifying device 10 is used in a compressor 300, the angle of attack γ may be angled from the radial direction 24 in a rotation direction ω of a compressor wheel 320. A rotation direction ω is depicted by way of example in FIGS. 1A and 3A. This advantageous embodiment leads to an improved fluid flow into the pocket 200. A greater volume flow may hereby be recirculated in turn back through the pocket 200 in the direction of the downstream end region 154. With use of the flow-modifying device 10 in a compressor 300, a greater volume flow may thus be conducted back towards the compressor wheel 320, whereby in turn the efficiency may be increased.

A further possible embodiment of the flow-modifying device 10 is shown schematically merely in FIG. 3B and may be implemented additionally or alternatively to one, more or all of the possible embodiments. Here, an exemplary pocket 200 is shown relative to the axial direction 22. It can be seen here that the longitudinal projection line 202 may be inclined by a tilt angle S. This tilt angle δ may assume a value from 0°<δ<60°, preferably 5°<δ<45° and particularly preferably 10°≤δ≤30°. In particular, it is advantageous here if the longitudinal projection line 202 is angled from the axial direction 22 by the tilt angle δ in such a way that the upstream opening region 216 is angled from the axial direction 22 against a rotation direction ω of a compressor wheel 320. This has the advantage in particular that the fluids flowing out from the pocket 200 experience a movement component in the peripheral direction 26. Thus, an incident flow against a compressor wheel 320 can be improved.

Further dimensions of the pocket 200 will be explained with reference to FIGS. 2A-2C. These include, for example, a width 207 of the pocket 200, a length 208 of the pocket 200, a depth of 209 of the pocket 200, and an opening length 212 of the already described opening 210 of the pocket 200. These dimensions will be described in factorized fashion in order to cover a corresponding variance for different compressor applications of different sizes. In this case, the factor F_{D} is used and is defined as follows: F_{D}=D/D_{Ref}. D_{Ref} corresponds here to a reference outlet diameter of a compressor wheel 320 and is preferably 60 mm. D corresponds here to an outlet diameter of a compressor wheel 320 of the compressor 300 of the present application. This means that D corresponds here to an outlet diameter of a compressor wheel 320 of the compressor 300, for which the flow-modifying device 10 is designed. In other words, this means that the dimensions of the pocket 200, in particular the width 207, the length 208, the depth 209 and the opening length 212 is configured depending on the dimensions of the compressor wheel 320 for the operation of which the flow-modifying device 10 is designed or together with which said flow-modifying device will be used. Specifically, the width 207 of the pocket 200 assumes a value here between 1 mm×F_{D} and 6 mm×F_{D}, preferably a value between 2 mm×F_{D} and 5 mm×F_{D} and particularly preferably a value between 3 mm×F_{D} and 4 mm×F_{D}. The width 207 shall be considered here orthogonally to the orientation plane 203. This means that the width 207 shall be considered here as the distance between the side walls 232, 234 (see FIGS. 2B and 2C). Specifically, the length 208 of the pocket 200 assumes a value here between 5 mm×F_{D} and 30 mm×F_{D}, preferably a value between 10 mm×F_{D} and 25 mm×F_{D} and particularly preferably a value between 15 mm×F_{D} and 20 mm×F_{D}. The length 208 runs here along the longitudinal projection line 202. This means that the length 208 runs in the orientation plane 203. In other words, the length 208 corresponds here to a maximum extent of the pocket 200 in the orientation plane 203 along the longitudinal projection line 202 (see FIGS. 2A and 2B). Specifically, the depth 209 of the pocket 200 assumes a value here between 5 mm×F_{D} and 30 mm×F_{D}, preferably a value between 10 mm×F_{D} and 25 mm×F_{D} and particularly preferably a value between 15 mm×F_{D} and 20 mm×F_{D}. The depth 209 runs here along the depth projection line 204. This means that the depth 209 runs in the orientation plane 203. In other words, the depth 209 corresponds here to a maximum extent of the pocket 200 starting from the inner lateral surface 152 or from the opening face 211 along the depth projection lines 204 into the material of the cylindrical housing portion 150, as far as the deepest point of the pocket 200 (see FIGS. 2A and 2C). Specifically, the opening length 212 of the pocket 200 assumes a value here between 2 mm×F_{D} and 25 mm×F_{D}, preferably a value between 5 mm×F_{D} and 20 mm×F_{D} and particularly preferably a value between 10 mm×F_{D} and 15 mm×F_{D}. The opening length 212 in this case runs along the longitudinal projection line 202. This means that the opening length 212 runs in the orientation plane 203. The opening length 212 is delimited in the downstream opening region 214 and in the upstream opening region 216 by the opening contour 210a (see FIGS. 2A and 2B).

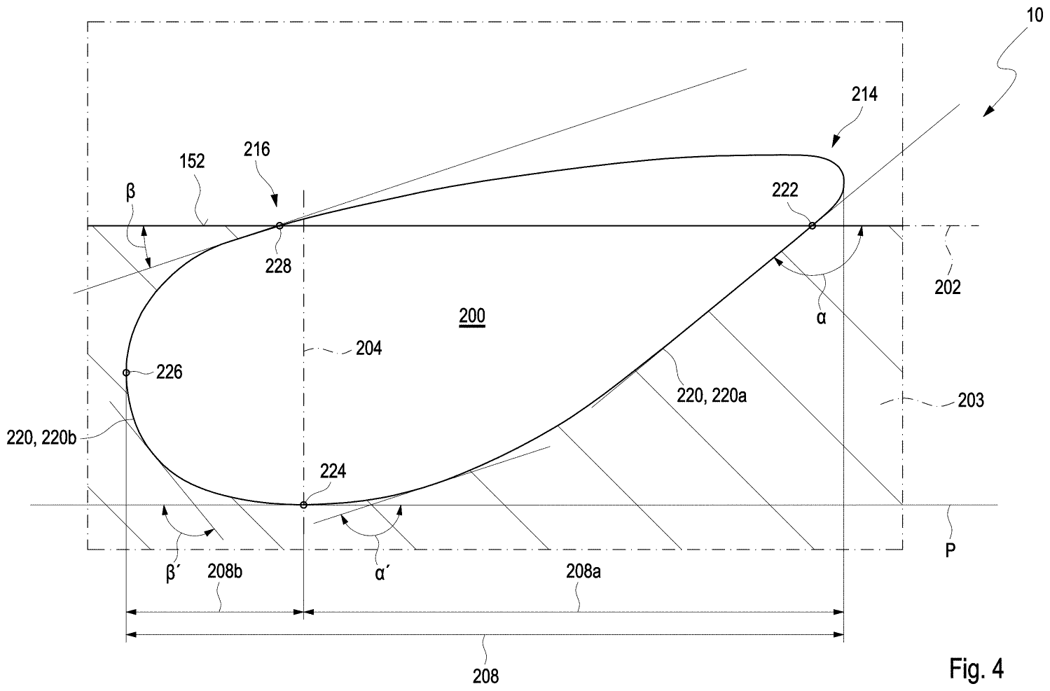

Further properties of the pocket 200 will be explained hereinafter with reference to FIG. 4. Here, it can be seen that the pocket 200 may be defined more precisely by a contour 220, which lies in the orientation plane 203. This means that the contour 220 is a kind of contour line of the pocket 200 in a section in the orientation plane 203. The contour 220 has an entry point 222 at which the downstream angle of entry α is present, an exit point 228 at which the upstream angle of entry β is present, and a change point 224, which lies between the entry point 222 and the exit point 228. The entry point 222 is determined here by a downstream point of intersection between the longitudinal projection line 202 in the opening contour 210a (see FIG. 2B). The exit point 228 is determined by an upstream point of intersection between the longitudinal projection line 202 in the opening contour 210a (see FIG. 2B). The change point 224 represents the deepest point of the contour 220 relative to the longitudinal projection line 202. This means that the change point 224 may be considered to be the deepest point of the contour 220. In other words, the change point 224 may be formed as a point of intersection of the depth projection line 204 with the pocket 200 of depth 209. A first contour portion 220a with a variable angle α′ is formed between the entry point 222 and the change point 224. A second contour portion 220b with a variable angle β′ is formed between the change point 224 and the exit point 228. The variable angles α′ and β′ are considered relative to the lateral inner surface 152. This means that the variable angles α′ and β′ are considered analogously to the downstream entry angle α and to the upstream entry angle β. More precisely, the variable angles α′ and (3′ are also considered analogously relative to a parallel P of the longitudinal projection line 202 at the depth 209 of the pocket 200 according to the Z angle (see FIG. 4). The first contour portion 220a extends here within a downstream length portion 208a of the length 208 of the pocket 200. The second contour portion 220b extensive within an upstream length portion 208b of the length 208 of the pocket 200.

The contour 220 in this case has such a profile that the variable angle changes from α′=α at the entry point to α′=180° at the change point 224. Here, the variable angle α′ changes from the entry point 222 to the change point 224 in such a way that the profile of the first contour portion 220a from the entry point 222 to the change point 224 does not have any sudden changes or kinks, and the variable angle α′ at least does not become smaller. In other words, the profile of the first contour portion 220a may be defined as differentiable, and the variable angle α′ in its course from the entry point 222 to the change point 224 at least does not become smaller. The contour 220 in this case has such a profile that the variable angle β′ changes from β′=180° at the change point 224 to β′=β at the exit point 228, in such a way that the profile of the second contour portion 220b from the change point 224 to the exit point 228 does not have any sudden changes or kinks, and the variable angle β′ at least does not become larger. In other words, the profile of the second contour portion 220b may be defined as differentiable, and alternatively or additionally the variable angle β′ in its course from the change point 224 to the exit point 228 at least does not become larger. These particularly advantageous embodiments lead to improved and more uniform flow conditions within a pocket 200.

It can also be seen in FIG. 4 that the contour 220 between the change point 224 and the exit point 228 has a turning point 226. More precisely, the turning point 226 is arranged in the second contour portion 220b. The turning point 226 is arranged between the change point 224 and the exit point 228. The turning point 226 here defines the maximum length 208 of the pocket 200, in particular the maximum length 208 of the pocket 200 in the upstream direction. The turning point 226 is thus defined in that, for the variable angle β′:β′=90°. In other words, the turning point may be defined in that the variable angle β′ over its course from the change point 224 to the exit point 228 reaches a value of β′=90° for the first time.

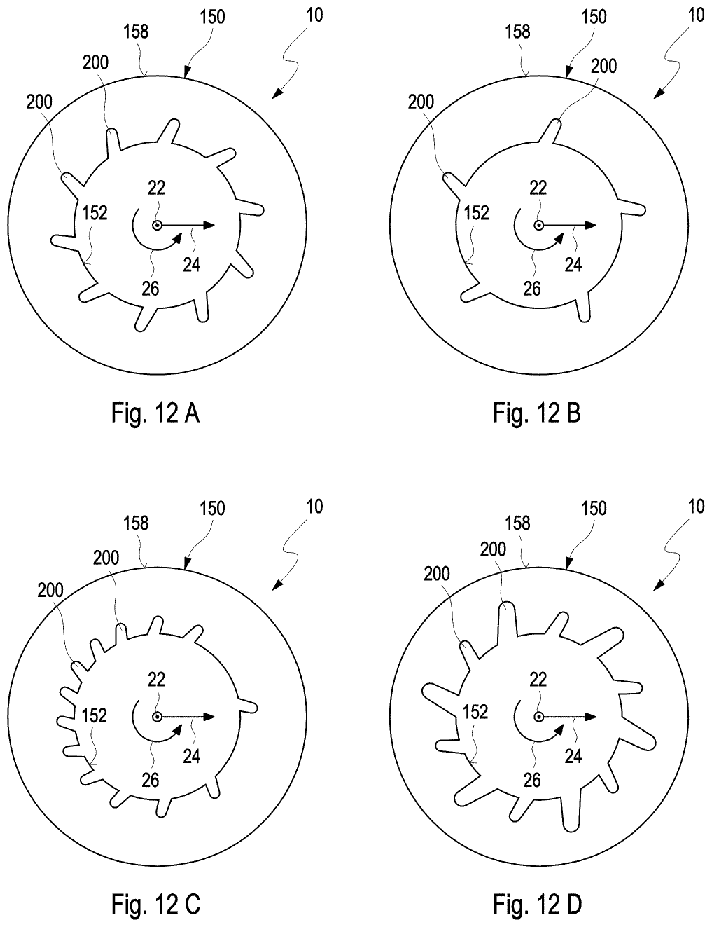

FIGS. 12A-12D show different flow-modifying devices 10 with different designs and arrangements of the pockets 200 in the cylindrical housing portion 150. In comparison to FIG. 1A, in which the flow-modifying device 10 comprises 19 pockets 200, the flow-modifying devices 10 in FIGS. 12A and 12B each have only 10 or 5 pockets 200. For example, depending on the operating requirements of the flow-modifying device 10 when used in a compressor 300 and/or different designs of the pockets 200 (for example different design of the width 207, the length 208, the depth 209, the angles α, a′, (3, (3′ and/or the opening length 212 of a pocket 200), the flow-modifying device 10 may have different numbers of pockets 200, also more than 19, fewer than 5, or other numbers between 5 and 19. Here, FIG. 12D shows an example of a flow-modifying device 10 in which differently designed pockets 200 are provided. Although in FIG. 12D only two different kinds of designs of pockets 200 are shown, more of the pockets could also be formed differently from other pockets 200 (for example 3, 4, 5, etc. different kinds of designs of pockets 200). In particular, one or more of the dimensions of one or more pockets 200, that is to say a width 207 and/or a length 208 and/or a depth 209 and/or an opening 210 with an opening length 212 and/or one or more of the angles α, α′, β, β′ may be formed differently from one or more of the dimensions of the other pockets 200. In the examples in FIGS. 1A, 12A, 12B and 12D, the pockets 200 are arranged equidistantly in the peripheral direction 26. In alternative embodiments the pockets 200 may also be arranged at irregular distances in the peripheral direction 26 (see FIG. 12C). In particular, combinations of different arrangements having different designs of pockets 200 are also possible.

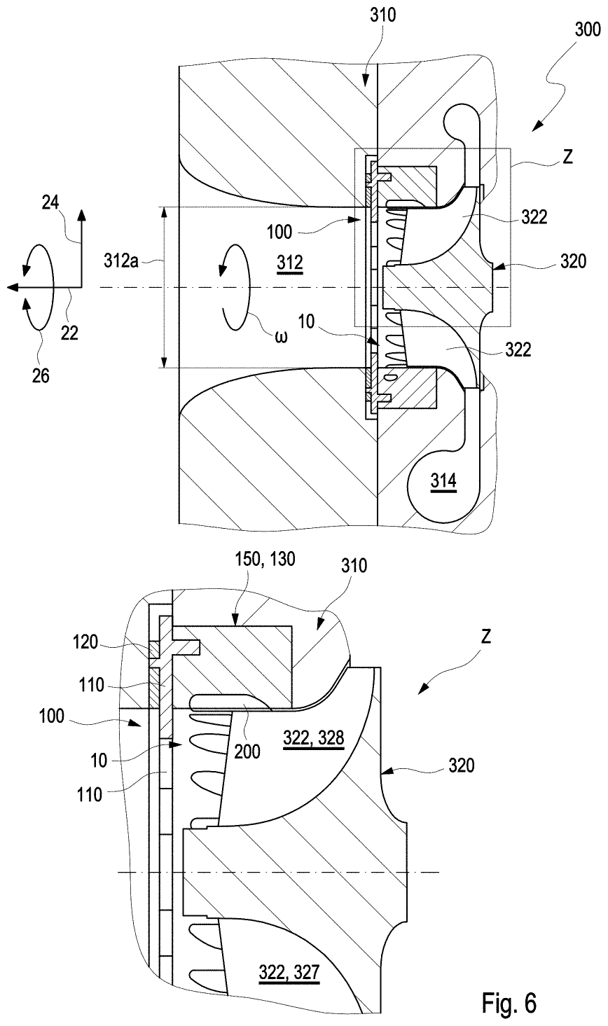

The invention also relates to a compressor 300 for a charging apparatus 400, which is shown schematically in a sectional view from the side in FIG. 5 and the associated detail Y. The detail Y is situated here in the region Y of FIG. 5, but runs in the region of the pocket 200 through a section along the orientation plane 203 of the pocket 200. This means that FIG. 5 and the associated detail Y are shown in principle in the section C-C of FIG. 1, however the upper pocket 200, which is explained in greater detail in the detailed view Y, is shown in a section along the orientation plane 203 of the pocket 200 so as to be able to describe the opening length 212 accordingly. By comparison, FIG. 6 and the associated detail Z are shown fully in the section C-C of FIG. 1. The compressor 300 comprises a compressor housing 310, a compressor wheel 320, and the flow-modifying device 10. The compressor housing 310 defines a compressor inlet 312 having an inlet cross-section 312a and a compressor outlet 314. The compressor wheel 320 is arranged between the compressor inlet 312 and the compressor outlet 314 so as to be rotatable in the compressor housing 310. As already mentioned further above, by use of the flow-modifying device 10 in a compressor 300, a significant improvement of the characteristic map stability may be achieved. In particular, both the lower and the upper characteristic map region may be stabilized. Compared to a “ported shroud” known from the prior art, the efficacy can be seen already at lower pressure ratios. If the compressor 300 is used for an internal combustion engine, the specific embodiment of the flow-modifying device 10 with the pockets 200 enables a noticeable shift of the operating points close to the surge line toward smaller throughputs (or toward higher pressure with constant throughput). As a result, an earlier and higher torque can be provided at the internal combustion engine. The flow-modifying device 10 may be introduced here as a retrofit measure into existing parts by means of machining. Different customer applications may hereby be covered by identical unmachined parts. This results in manufacturing and financial advantages due to a high degree of part standardization.

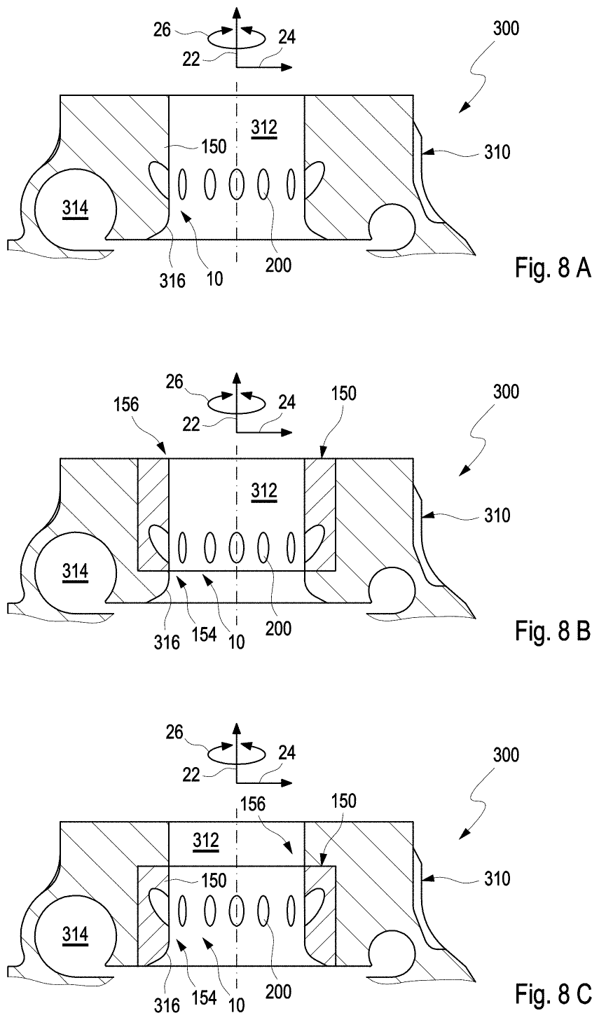

In the example of FIG. 5, the cylindrical housing portion 150 of the flow-modifying device 10 is produced integrally with the compressor housing 310. Alternatively, however, the cylindrical housing portion 150 may also be produced as a separate component. In this regard, FIGS. 8A-8C show a simplified compressor housing 310 with a flow-modifying device 10 shown in heavily simplified form and without turbine wheel 320. Here, in FIG. 8A, a cylindrical housing portion 150 produced integrally with the compressor housing 310 is compared with a cylindrical housing portion 150, which is produced as a separate component from FIGS. 8B and 8C. Here, the flow-modifying device 10 or the cylindrical housing portion 150 may be designed to be insertable into the compressor housing 310 from the compressor inlet 312 in the axial direction 22 to the compressor outlet 314 (see FIG. 8B) or from the compressor outlet 314 in the axial direction to the compressor inlet 312, that is to say in the opposite direction (see FIG. 8C). In particular if the cylindrical housing portion 150 is insertable into the compressor housing 310 from the compressor outlet 314 in the axial direction 22 to the compressor outlet 312 into the compressor housing 310, a compressor contour 316 may be formed by the cylindrical housing portion 150. Since this compressor contour 316 is formed on the separate cylindrical housing portion 150, the geometry/surface of the compressor contour 316 is more flexible and more easily accessible for exact machining. Due to an integral manufacture of the cylindrical housing portion 150 with the compressor housing 310, the flow-modifying device 10 may be integrated into existing compressor geometries. If the cylindrical housing portion 150 is formed as a separate component, identical compressor housings 310, into which flow-modifying devices 10 of different designs are insertable, may be used for different compressor applications as appropriate. Furthermore, advantages in respect of the manufacturing process and/or used material may be provided in some circumstances if the cylindrical housing portion 150 is formed as a separate component. On the whole, manufacturing and financial advantages may be provided as a result of these embodiments due a high degree of part standardization.

FIG. 6 and the associated detail Z show a further embodiment of the compressor 300 in which the compressor 300 comprises an adjustment mechanism 100 having a plurality of aperture elements 110 for changing the inlet cross-section 312a. For this embodiment of the compressor 300, all previously explained variation possibilities of the compressor 300 and/or of the flow-modifying device 10 are also applicable. The flow-modifying device 10 is arranged here downstream of the adjustment mechanism 100 or downstream of the aperture elements 100. More precisely, the cylindrical housing portion 150 is arranged downstream of the adjustment mechanism 100 or downstream of the aperture elements 110. regardless of whether the cylindrical housing portion 150 is manufactured integrally with the bearing housing 310 or as a separate component, the cylindrical housing portion 150 may be configured as a bearing ring 130 for the aperture elements 110 (see FIG. 6). A separate pre-manufacturable module for use in the compressor 300 may hereby be provided. Furthermore, the compressor 300 or the combination of adjustment mechanism 100 and flow-modifying device 10 may thus be made more compact. For the sake of completeness, it should be noted that the adjustment mechanism 100 comprises an adjustment ring 120 for adjusting the aperture elements 110 (see the detail Z in FIG. 6).

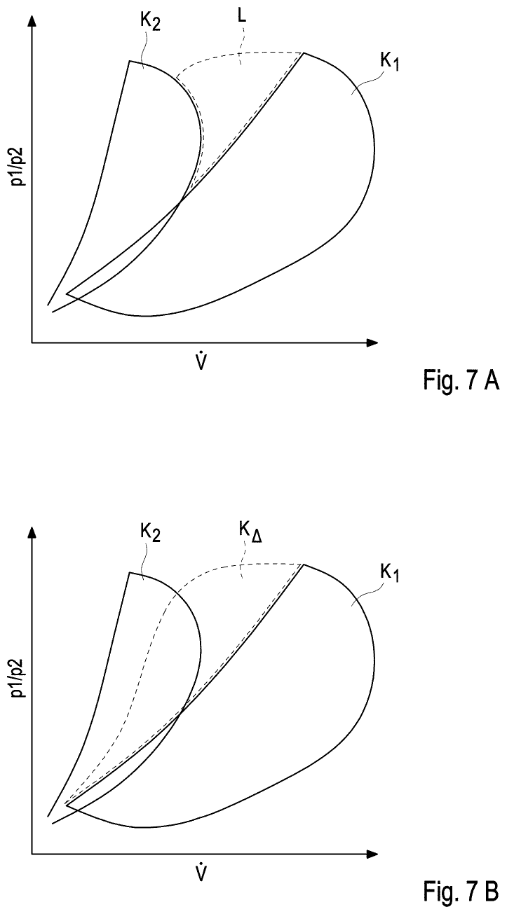

Due to the combined use of the flow-modifying device 10 with the adjustment mechanism 100, a further improvement of the characteristic map stability, both in the lower and in the upper characteristic map region, may be attained. The adjustment mechanism 100 may be actuated in this case between a first, open position and a second, closed position. The inlet cross-section 312a is unchanged in the first position. By contrast, the inlet cross-section 312a is reduced in the second position (see FIG. 6). In particular with low volume flows and/or low pressure ratios, the compressor characteristic map may be optimized by the adjustment mechanism 100 by moving the adjustment mechanism 100 into the second position. There are thus two different characteristic map regions K₁ (closed) and K₂ (open) in the two different positions of the adjustment mechanism 100, which map regions are separated from one another in a boundary region by a gap region L. This relationship is shown in FIG. 7A, which comprises a compressor characteristic map in which the pressure ratio p₁/p₂ is plotted over the volume flow \dot{V} for a compressor which comprises only an adjustment mechanism 100 and no flow-modifying device 10. In the compressor characteristic map of FIG. 7A, the two characteristic map regions K₁ (closed) and K₂ (open) and the gap region L are plotted. Due to the adjustment mechanism 100, a substantial extension of the characteristic map region K₁ toward the characteristic map region K₂ to lower volume flows \dot{V} and lower pressure ratios p₁/p₂ can thus be achieved, However, for operating points in the gap region L, a surge or choke (depending on the direction in which the adjustment mechanism 100 is situated) of the compressor may occur. By contrast, FIG. 7B shows that the compressor characteristic map of a compressor 300 according to the invention comprises both the adjustment mechanism 100 and the flow-modifying device 10. It can be seen that in particular the characteristic map region K₁ (open position) can be extended substantially in the direction of lower volume flows \dot{V} and lower pressure ratios p₁/p₂ by the characteristic field region K_{Δ} (shown by a dashed line) in comparison to the characteristic field region K₁ of FIG. 7A. This may be achieved by the combination of the adjustment mechanism 100 with the specific embodiment of the flow-modifying device 10, whereby the gap region L from FIG. 7A may be significantly reduced. As a result of this surprising effect with a combined use of the adjustment mechanism 100 with the flow-modifying device 10, a significantly improved compressor 300 with an improved compressor characteristic map or characteristic field regions in both positions of the adjustment mechanism 100 can be provided.

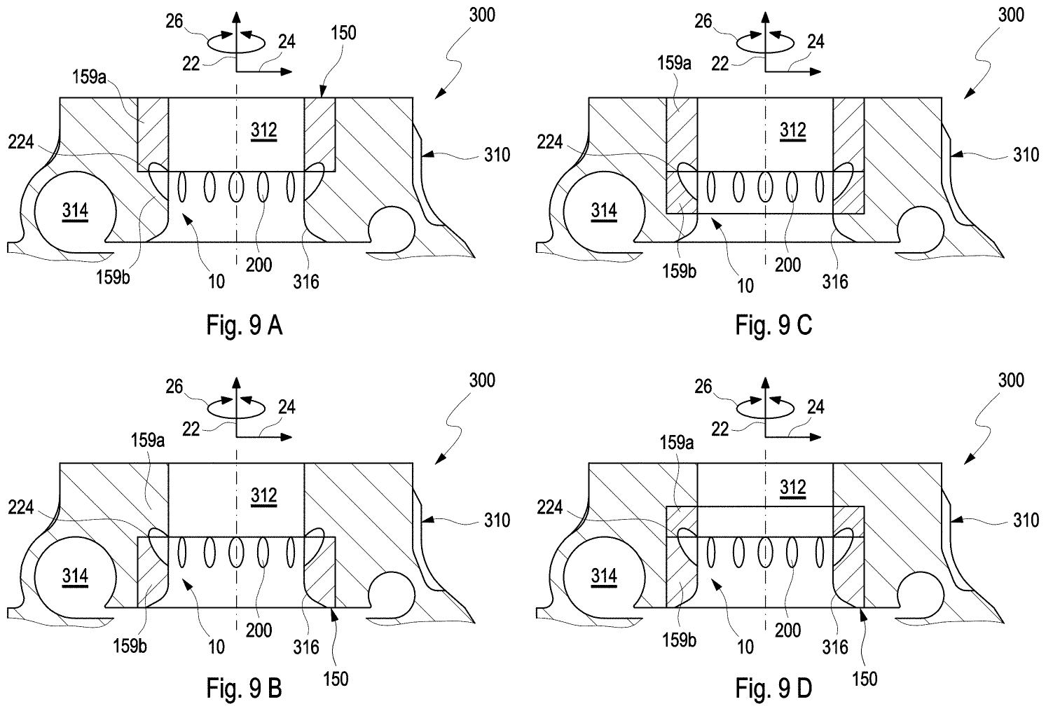

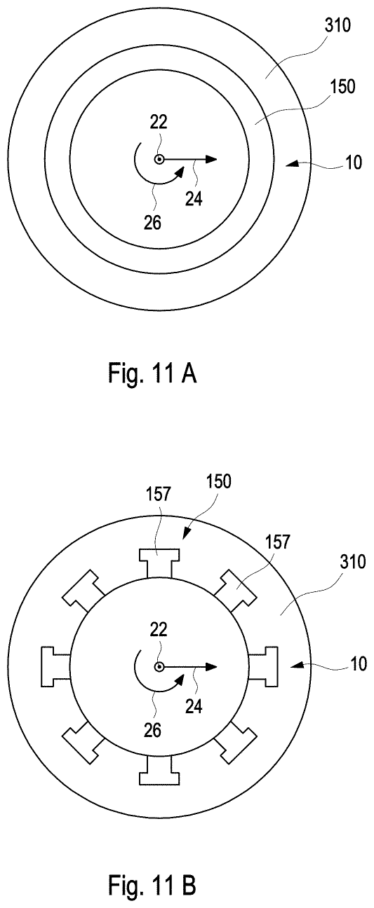

FIGS. 9A-9D and 11B show exemplary embodiments in which the cylindrical housing portion 150 is constructed in a number of parts. As is shown in FIG. 11B, the cylindrical housing portion 150 may comprise a plurality of sub-portions 157 in the peripheral direction 26. These sub-portions 157 in the peripheral direction 26 may also be referred to as peripheral sub-portions 157. For example, a separate peripheral sub-portion 157 may be provided here for each pocket 200 (see FIG. 11B). Alternatively, a peripheral sub-portion 157 may also accommodate a plurality of pockets 200. Although 8 peripheral sub-portions 157 are shown in the example of FIG. 11B, the cylindrical housing portion 150 may also comprise more or fewer peripheral sub-portions 157. A peripheral sub-portion 157 may be substantially T-shaped in cross-section, so as to be secured against slipping out in the radial direction 24 (see also FIG. 11B). By contrast, the cylindrical housing portion 150, as also show in FIG. 11A, may also consist of a single component in the peripheral direction 26. It should be noted that FIGS. 9A-9D, 11A and 11B show heavily simplified compressor housings 310 with likewise heavily simplified flow-modifying devices 10.

By contrast, FIGS. 9A-9D show how the cylindrical housing portion 150 may comprise a plurality of sub-portions 159 in the axial direction 22. These sub-portions 159 in the axial direction 22 may also be referred to as axial sub-portions 159. In particular, the cylindrical housing portion 150 may consist of a first sub-portion 159a in the axial direction 22 and a second sub-portion 159a in the axial direction 22 (see FIGS. 9C and 9D). The first axial sub-portion 159a and the second axial sub-portion 159b are formed here in particular annularly. In this case, the first axial sub-portion 159a and the second axial sub-portion 159b are formed in such a way that they separate the pockets 200 at their deepest point. In other words, this means that the first axial sub-portion 159a and the second axial sub-portion 159b divide the pockets 200 at the change point 224. This has manufacturing advantages in particular, such as simplified access to the pocket 200.

As can be seen in FIGS. 9A and 9B, one of the first axial sub-portion 159a and the second axial sub-portion 159b may be manufactured integrally with the compressor housing 310. In such embodiments, the other of the first axial sub-portion 159a and the second axial sub-portion 159b may be insertable into the compressor housing 310 from the compressor inlet 312 in the axial direction 22 to the compressor outlet 314 or from the compressor outlet 314 in the axial direction 22 to the compressor inlet 312. This applies similarly also for a cylindrical housing portion 150 with a first axial sub-portion 159a and a second axial sub-portion 159b, neither of which is manufactured integrally with the compressor housing 310. In this case, for example, both the first axial sub-portion 159a and the second axial sub-portion 159b may be insertable into the compressor housing 310 from the compressor inlet 312 in the axial direction 22 to the compressor outlet 314 (see FIG. 9C). Alternatively, the first axial sub-portion 159a and the second axial sub-portion 159b may be insertable into the compressor housing 310 from the compressor outlet 314 in the axial direction 22 to the compressor inlet 312 into the compressor housing 310. A corresponding adaptation of the compressor housing 310 in accordance with the particular insertion direction of the cylindrical housing portion 150 is self-evident and is clear from FIGS. 9A-9D. In particular, if the cylindrical housing portion 150 is insertable into the compressor housing 310 from the compressor outlet 314 in the axial direction 22 to the compressor inlet 312, the compressor contour 316 may be formed by the cylindrical housing portion 150. Since this compressor contour 316 is formed on the separate cylindrical housing portion 150, the geometry/surface of the compressor contour 316 is more flexible and more easily accessible for exact machining.

It should be noted in principle that combinations of different peripheral sub-portions 157 and axial sub-portions 159 are also possible. For example, the first axial sub-portion 159a and/or the second axial sub-portion 159b also have two or more peripheral sub-portions 157.

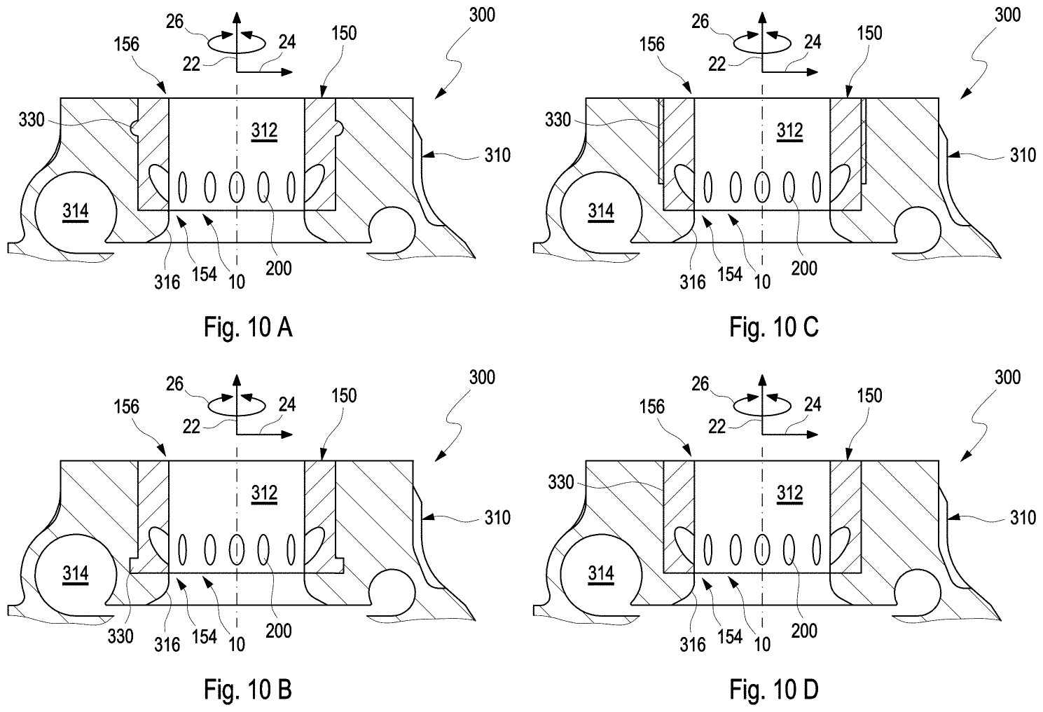

FIGS. 10A-10D schematically show various fastening devices 330 of the cylindrical housing portion 150 of the flow-modifying device 10 in heavily simplified form by way of example. More specifically, the flow-modifying device 10 may be fastened in the compressor housing 310 via its cylindrical housing portion 150, if this is formed as a separate part. In this case, FIGS. 10A and 10B show two different embodiments of fastening devices 330 in the form of snap-fit connections between the cylindrical housing portion 150 and the compressor housing 310. The snap-fit connection is arranged here on the outer lateral surface 158. In the axial direction 22, the snap-fit connection may be arranged at different positions of the cylindrical housing portion 250. For example, the snap-fit connection may be arranged in the upstream end region 156 (not shown), in the downstream end region 154 (see FIG. 10B) or axially between the upstream end region 156 and the downstream end region 154 (see FIG. 10A). FIG. 10C shows an embodiment of the fastening devices 330 as a screwed connection, in which the cylindrical housing portion 150 is screwed via a thread on its outer lateral surface 158 to a thread on an inner lateral surface of the compressor housing 310. FIG. 10D shows an embodiment of the fastening devices 330 as a press-fit connection, in which the cylindrical housing portion 150 is held in the compressor housing 310 frictionally via a press fit between its outer lateral surface 158 and an inner lateral surface of the compressor housing 310. The embodiments just described also apply similarly for embodiments of the flow-modifying device 10 in which individual or all sub-portions 157, 159 (if provided) and not the entire cylindrical housing portion 150 are manufactured separately.

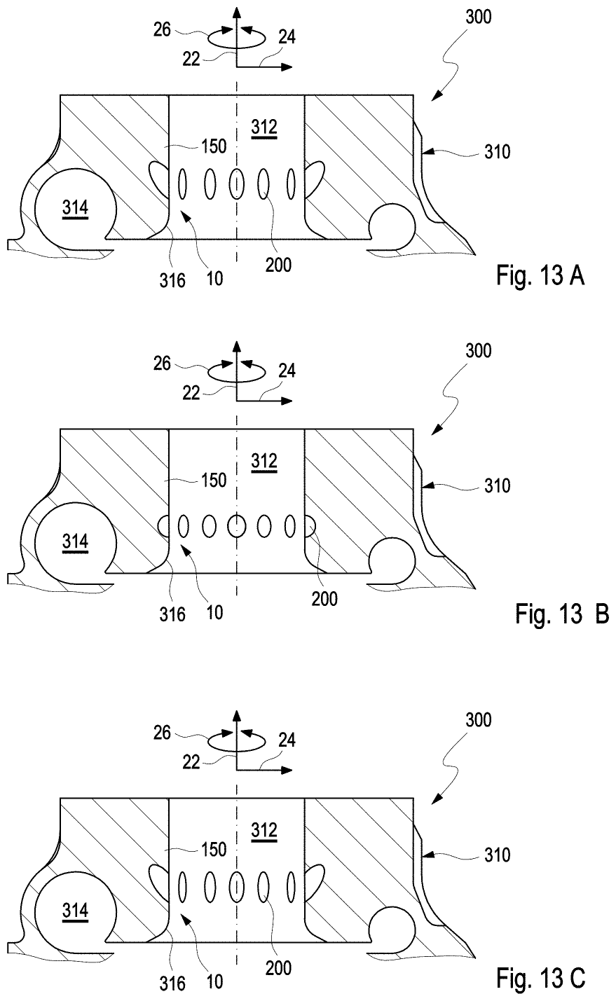

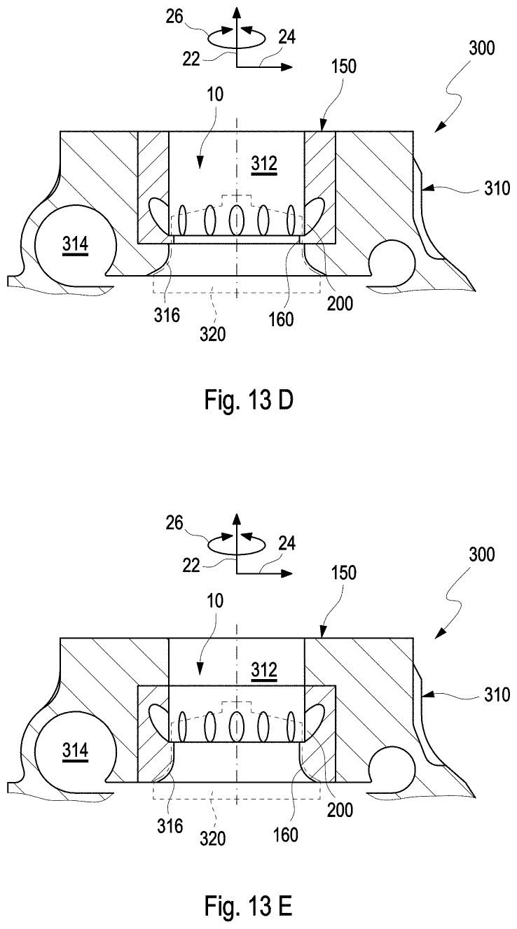

If the cylindrical housing portion 150 is manufactured as a separate component, it may be advantageous to produce the cylindrical housing portion 150 from plastic. The cylindrical housing portion 150 in this case may optionally have an overdimension 160 in the direction of the compressor wheel 320 (see FIGS. 13D and 13E). For improved clarity, merely the outer contours of the compressor wheel 320 have been shown by a dashed line in FIGS. 13D and 13E. The cylindrical housing portion 150, in the state immediately following insertion into the compressor, has an overdimension 160. In FIG. 13D the flow-modifying device 10 or the cylindrical housing portion 150 is designed to be inserted into the compressor housing 310 from the compressor inlet 312 in the axial direction 22 to the compressor outlet 314. Here, the overdimension 160 is provided only in a partial region of the compressor contour 316. In FIG. 13E the flow-modifying device 10 or the cylindrical housing portion 150 is designed to be inserted into the compressor housing 310 from the compressor outlet 314 is the axial direction 22 to the compressor inlet 312. Here, the overdimension 160 is formed in the region of the compressor contour 316. In other words, this means that the overdimension 160 is formed downstream in the axial direction 22 and inwardly in the radial direction 24. During operation of the compressor 300, the overdimension 160 may be reduced, in particular ground down or abraded, by the compressor wheel 320. This means that the compressor wheel 320, which is made of a metallic material, may remove or abrade the softer and unnecessary plastic material of the cylindrical housing portion 150 in the region of the overdimension 160. Precisely one accurately fitting compressor contour 316 may thus be produced, which is shaped in a manner complementary to the contour of the compressor wheel 320. A collision-free (following the abrasion by the compressor wheel) rotation of the compressor wheel 320 is thus made possible. A reduced necessary manufacturing tolerance advantageously results. This may lead in turn to reduced manufacturing costs and to a simplification of the entire manufacturing process.

The invention also comprises a method for producing the compressor 300 or the flow-modifying device 10. As already mentioned, the cylindrical housing portion 115 may be provided here integrally with the compressor housing 310 or as a separate component. Merely individual, a plurality, or all of the sub-portions 157, 159 (if provided) may also be provided integrally with the compressor housing 310 or as separate components. If the cylindrical housing portion 150 or the sub-portions 157, 159 are provided as separate components, the pockets 200 may be produced directly with the cylindrical housing portion 150 or the sub-portions 157, 159, for example in an injection-molding process. Alternatively, the pockets 200 may be formed subsequently in the cylindrical housing portion 150 or in the sub-portions 157, 159 by means of material-removing processes. In particular if the cylindrical housing portion 150 or the sub-portions 157, 159 (if provided) are provided integrally with the compressor housing 310, the pockets 200 may be formed in the cylindrical housing portion 150 or in the sub-portions 157, 159 or in the compressor housing 310 by various manufacturing methods. In this regard, FIG. 13A by way of example shows pockets 200 which are formed in the compressor housing 310 in an erosion process. FIGS. 13B and 13C show a combination of a casting method, in which a basic form of the pockets 200 is already provided in the compressor housing 310 (see FIG. 13B), followed by a material-removing process, in particular a milling process, by means of which the ultimate geometry of the pocket 200 (as described further above) is produced (see FIG. 13C). This means that the pockets 200 may be produced by an erosion process, a casting process, a material-removing process or any combination of two or more of the aforementioned and/or further suitable processes.

The position of the pockets 200 relative to the compressor wheel 320 is described with reference to FIG. 5 and the detail Y. The compressor wheel 320 comprises a plurality of blades 320 distributed in the peripheral direction 26, as is also known from the prior art. In FIG. 5 two blades 322 are shown in this regard. Each blade 322 in this case has a leading-edge 324, a side edge 325, a trailing edge 326, a frontside 327, and a rear side 328. This can be seen in the detail Y, in which, however, the compressor housing 310 or the pocket 200 is not shown along the section C-C, but along a section through the orientation plane of the pocket 20. For perspective reasons, only the rear side 328 can be seen for one blade 322, and only the frontside 327 can be seen for the other blade. The frontside 327 and the rear side 328 can be seen here relative to the rotation direction ω of the compressor wheel 320. The pockets 200 are arranged here in the axial direction 22 or in an axial position, in such a way that the opening 210 of each pocket 200 is situated both upstream and downstream of a vertex 329 at which the leading-edge 324 and the side edge 325 converge. In the exemplary embodiment in FIG. 5 or the detail Y, the pocket 200 are arranged in the axial direction 22 or in an axial position, in such a way that a center of the opening 210, which lies at the halfway point of the opening length 212, is situated approximately at the vertex 329. In alternative embodiments, other arrangements are also possible. For example, a ratio between a downstream opening length 212a, which is downstream of the vertex 329, and an upstream opening length 212b, which is arranged upstream of the vertex 329, may also be greater than or less than 1.

As already mentioned, the angle of attack γ is angled from the radial direction 24 in a rotation direction ω of the compressor wheel 320. This advantageous embodiment leads to an improved flow of fluid into the pocket 200. A greater volume flow may thus in turn be conducted or recirculated through the pocket 200 and back in the direction of the downstream end region 154, that is to say back to the compressor wheel 320, whereby in turn the efficiency may be increased.

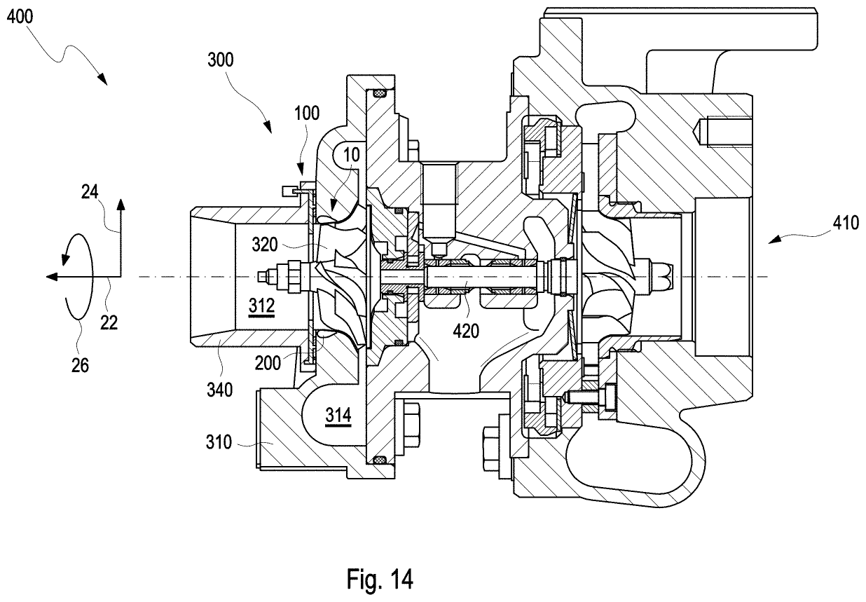

The invention also relates to a charging apparatus 400 (see FIG. 14). The charging apparatus 400 comprises the compressor 300. The compressor 300 shown in FIG. 14 comprises a flow-modifying device 10 and an adjustment mechanism 100. The cylindrical housing portion 150 is formed here integrally with the compressor housing 310. Alternatively, however, the cylindrical housing portion 150 may also be formed as a separate component. In principle, all further above-mentioned variants are transferable to the charging apparatus 400. For example, the compressor 300 may also comprise merely a flow-modifying device 10 and no adjustment mechanism 100. In the exemplary illustration of FIG. 14, the compressor 300 also comprises a compressor inlet nozzle 340, which is arranged upstream of the compressor housing 310 in the axial direction 220 and is fastened thereto. In this case, the adjustment mechanism 100 is arranged axially between the compressor inlet nozzle 340 and the compressor housing 310. The charging apparatus 400 also comprises a shaft 420, via which the compressor 300 and the drive unit 410 are coupled to one another for conjoint rotation. The drive device 410 in the shown exemplary embodiment is a turbine. Alternatively or additionally, however, the drive unit 410 may also comprise an electric motor.

List of reference numerals

| | |
|---|---|
| 10 | flow-modifying unit |
| 22 | axial direction |
| 24 | radial direction |
| 26 | peripheral direction |
| 100 | adjustment mechanism |
| 110 | aperture elements |
| 120 | adjustment ring |
| 130 | bearing ring |
| 150 | cylindrical housing portion |
| 152 | inner lateral surface |
| 153 | downstream end face |
| 154 | downstream end region |
| 155 | upstream end face |
| 156 | upstream end region |
| 157 | peripheral sub-portions |
| 158 | outer lateral surface |
| 159 | axial sub-portions |
| 160 | overdimension |
| 200 | pocket |
| 202 | longitudinal projection line |
| 203 | orientation plane |
| 204 | depth projection line |
| 207 | width of the pocket |
| 208 | length of the pocket |
| 208a | downstream length portion |
| 208b | upstream length portion |
| 209 | depth of the pocket |
| 210 | opening |
| 210a | opening contour |
| 211 | opening face |
| 212 | opening length |
| 212a | downstream opening length |
| 212b | upstream opening length |
| 214 | downstream opening region |
| 216 | upstream opening region |
| 220 | contour |
| 222 | entry point |
| 224 | change point |
| 226 | turning point |
| 228 | exit point |
| 232 | first side wall |
| 234 | second side wall |
| 300 | compressor |
| 310 | compressor housing |
| 312 | compressor inlet |
| 312a | inlet cross-section |
| 314 | compressor outlet |
| 316 | compressor contour |
| 320 | compressor wheel |
| 322 | blades |
| 324 | leading edge |
| 325 | side edge |
| 326 | trailing edge |
| 327 | front side |
| 328 | rear side |
| 329 | vertex |
| 330 | fastening device |
| 340 | compressor inlet nozzle |
| 400 | charging apparatus |
| 410 | drive unit |
| 420 | shaft |
| P | parallel to the longitudinal projection line |
| X | detail |
| α | downstream entry angle |
| α′ | variable downstream angle |
| β | upstream entry angle |
| β′ | variable upstream angle |
| γ | angle of attack |
| δ | tilt angle |
| ω | rotation direction |

Although the present invention has been described above and is defined in the accompanying claims, it should be understood that the invention also can be defined alternatively in accordance with the following embodiments:
1. Flow-modifying device (10) for a compressor (300) of a charging apparatus (400) comprising:
   a cylindrical housing portion (150), which defines an inner lateral surface (152) and in the axial direction (22) comprises a downstream end region (154) and an upstream end region (156); and
   a plurality of pockets (200), which are arranged on the inner lateral surface (152), spaced-apart from one another in the peripheral direction (26);
      wherein each pocket (200) is defined by a longitudinal projection line (202) and a depth projection line (204),
      wherein in an orientation plane (203), which is formed by the longitudinal projection line (202) and the depth projection line (204), a downstream angle of entry (α) of the pocket (200) relative to the inner lateral surface (152) defines a downstream opening region (214) of the pocket (200) and an upstream angle of entry (β) of the pocket (200) relative to the lateral inner surface (152) defines an upstream opening region (216) of the pocket (200), and
      wherein the pocket (200) is formed here in such a way that: (β)<90°<(α).
2. Flow-modifying device (10) according to embodiment 1, wherein the pocket (200) is formed in such a way that: (β)<180°−(α).
3. Flow-modifying device (10) according to either one of the preceding embodiments, wherein 10°<(β)<30°, preferably 15°<(β)<20° and particularly preferably 17°≤(β)≤19°.
4. Flow-modifying device (10) according to any one of the preceding embodiments, wherein 120°<(α)<165°, preferably 130°<(α)<150° and particularly preferably 135°≤(α)≤145°.
5. Flow-modifying device (10) according to any one of the preceding embodiments, wherein the depth projection line (204) is inclined relative to the radial direction (24) by an angle of attack (γ).
6. Flow-modifying device (10) according to embodiment 5, wherein 0°<(γ)<60°, preferably 15°<(γ)<50° and particularly preferably 35°≤(γ)≤45°.
7. Flow-modifying device (10) according to any one of the preceding embodiments, wherein a width (207) of the pocket (200) orthogonally to the orientation plane (203) is 1 mm×F_{D} to 6 mm×F_{D}, preferably 2 mm×F_{D} to 5 mm×F_{D} and particularly preferably 3 mm×F_{D} to 4 mm×F_{D}, where F_{D}=D/D_{Ref}, with D_{Ref} preferably being 60 mm and D corresponding to an outlet diameter of a compressor wheel of the compressor (300) for which the flow-modifying device (10) is designed.
8. Flow-modifying device (10) according to any one of the preceding embodiments, wherein a length (208) of the pocket (200) along the longitudinal projection line (202) is 5 mm×F_{D} to 30 mm×F_{D}, preferably 10 mm×F_{D} to 25 mm×F_{D} and particularly preferably 15 mm×F_{D} to 20 mm×F_{D}, where F_{D}=D/D_{Ref}, with D_{Ref} preferably being 60 mm and D corresponding to an outlet diameter of a compressor wheel of the compressor (300) for which the flow-modifying device (10) is designed.
9. Flow-modifying device (10) according to any one of the preceding embodiments, wherein a depth (209) of the pocket (200) along a depth projection line (204) is 5 mm×F_{D} to 30 mm×F_{D}, preferably 10 mm×F_{D} to 25 mm×F_{D} and particularly preferably 15 mm×F_{D} to 20 mm×F_{D}, where F_{D}=D/D_{Ref}, with D_{Ref} preferably being 60 mm and D corresponding to an outlet diameter of a compressor wheel of the compressor (300) for which the flow-modifying device (10) is designed.
10. Flow-modifying device (10) according to any one of the preceding embodiments, wherein the longitudinal projection line (202) is inclined relative to the axial direction (22) by a tilt angle (δ).
11. Flow-modifying device (10) according to embodiment 10, wherein 0°<(δ)<60°, preferably 5°<(δ)<45° and particularly preferably 10°≤(δ)≤30°.
12. Flow-modifying device (10) according to any one of the preceding embodiments, wherein the pocket (200) comprises an opening (210) with an opening face (211).
13. Flow-modifying device (10) according to embodiment 12, wherein the opening (210) comprises an opening length (212), and the opening length (212) extends along the longitudinal projection line (202) and is 2 mm×F_{D} to 25 mm×F_{D}, preferably 5 mm×F_{D} to 20 mm×F_{D} and particularly preferably 10 mm×F_{D} to 15 mm×F_{D}, where the factor F_{D}=D/D_{Ref}, with D_{Ref} preferably being 60 mm and D corresponding to an outlet diameter of a compressor wheel of the compressor (300) for which the flow-modifying device (10) is designed.
14. Flow-modifying device (10) according to either one of embodiments 12 or 13, wherein the longitudinal projection line (202) lies in a plane that is defined by the opening face (211).
15. Flow-modifying device (10) according to any one of the preceding embodiments, wherein the longitudinal projection line (202) runs centrally through the pocket (200) as considered in the peripheral direction (26), and optionally wherein the longitudinal projection line (202) runs centrally through the pocket (200) as considered in the peripheral direction (26), between the downstream opening region (214) and the upstream opening region (216).
16. Flow-modifying device (10) according to any one of the preceding embodiments, wherein the depth projection line (204) runs centrally through the pocket (200) as considered in the peripheral direction (26).
17. Flow-modifying device (10) according to any one of the preceding embodiments, wherein the pocket (200) comprises a length (208), an opening (210) with an opening length (212), and a depth (209).
18. Flow-modifying device (10) according to embodiment 17, wherein a contour (220) of the pocket (200) is determined by an entry point (222) at which the downstream angle of entry (α) is present, by an exit point (228) at which the upstream angle of entry (β) is present, and by a change point (224) between the entry point (222) and the exit point (228).
19. Flow-modifying device (10) according to embodiment 18, wherein the contour (220) lies in the orientation plane (203).
20. Flow-modifying device (10) according to either one of embodiments 18 or 19, wherein the entry point (222) is determined by a downstream point of intersection between the longitudinal projection line (202) and an opening contour (210a) of the opening (210), wherein the exit point (228) is determined by an upstream point of intersection between the longitudinal projection line (202) and the opening contour (210a), and wherein the change point (224) represents the deepest point of the contour (220) relative to the longitudinal projection line (202).
21. Flow-modifying device (10) according to any one of embodiments 18 to 20, wherein a first contour portion (220a) with a variable angle (α′) is formed between the entry point (222) and the change point (224) and a second contour portion (220b) with a variable angle (β′) is formed between the change point (224) and the exit point (228).
22. Flow-modifying device (10) according to embodiment 21, wherein (α′) changes from (α′)=(α) at the entry point (222) to (α′)=180° at the change point (224) in such a way that the profile of the first contour portion (220a) from the entry point (222) to the change point (224) does not have any sudden changes or kinks and (α′) at least does not become smaller.
23. Flow-modifying device (10) according to any one of embodiments 21 or 22, wherein (β)′ changes from (β)′=180° at the change point (224) to (β)′=(β) at the exit point (228) in such a way that the profile of the second contour portion (220b) from the change point (224) to the outlet point (228) does not have any sudden changes or kinks and (β)′ at least does not become larger.
24. Flow-modifying device (10) according to any one of the preceding embodiments, wherein the pockets (200) are arranged equidistantly in the peripheral direction (26).
25. Compressor (300) for a charging apparatus (400) comprising:
   a compressor housing (310), which defines a compressor inlet (312) with an inlet cross-section (312a) and a compressor outlet (314);
   a compressor wheel (320), which is arranged between the compressor inlet (312) and
   the compressor outlet (314) so as to be rotatable in the compressor housing (310); and
   a flow-modifying device (10) according to any one of the preceding embodiments.
26. Compressor (300) according to embodiment 25, further comprising an adjustment mechanism (100) having a plurality of aperture elements (110) for changing the inlet cross-section (312a).
27. Compressor (300) according to embodiment 26, wherein the cylindrical housing portion (150) is arranged downstream of the aperture elements (110).
28. Compressor (300) according to either one of embodiments 26 or 27, wherein the cylindrical housing portion (150) is configured as a bearing ring (130) for the aperture elements (110).
29. Compressor (300) according to any one of embodiments 25 to 28, wherein the cylindrical housing portion (150) is manufactured integrally with the compressor housing (310) or is manufactured as a separate component.
30. Compressor (300) according to any one of embodiments 25 to 29, wherein the cylindrical housing portion (150) is constructed in a number of parts and comprises a plurality of sub-portions (157) in the peripheral direction (26) and/or a plurality of sub-portions (159) in the axial direction (22).
31. Compressor (300) according to embodiment 30, wherein the cylindrical housing portion (150) consists of a first sub-portion (159a) in the axial direction (22) and a second sub-portion (159b) in the axial direction (22).
32. Compressor (300) according to embodiment 31, wherein one of the first or second sub-portion (159a, 159b) is manufactured integrally with the compressor housing (310), and optionally wherein the other of the first or second sub-portion (159a, 159b) is insertable into the compressor housing (310) from the compressor inlet (312) in the axial direction (22) to the compressor outlet (314) or from the compressor outlet (314) in the axial direction (22) to the compressor inlet (312).
33. Compressor (300) according to any one of embodiments 25 to 32, wherein the cylindrical housing portion (150), if this is formed as a separate part, is connected to the compressor housing (310) by a press fit, a snap-fit connection, a screwed connection or another suitable fastening device (330).
34. Compressor (300) according to any one of embodiments 25 to 33, wherein the cylindrical housing portion (150), if this is formed as a separate part, is insertable into the compressor housing (310) from the compressor inlet (312) in the axial direction (22) to the compressor outlet (314) or in the opposite axial direction (22).
35. Compressor (300) according to any one of embodiments 25 to 34, wherein the cylindrical housing portion (150), if this is formed as a separate part, is produced from plastic, and optionally wherein the cylindrical housing portion (150) has an overdimension (160) in the direction of the compressor wheel (320), which overdimension can be reduced, in particular can be ground down, by the compressor wheel (320) during operation of the compressor (300).
36. Compressor (300) according to any one of embodiments 25 to 35, wherein the compressor wheel (320) comprises a plurality of blades (322) distributed in the peripheral direction (26), wherein each blade (322) has a leading edge (324), a side edge (325), a trailing edge (326), a front side (327) and a rear side (328).
37. Compressor (300) according to embodiment 36, wherein the pockets (200) are arranged in the axial direction (22) in such a way that the opening (210) of a particular pocket (200) is situated both upstream and downstream of a vertex (329) at which the leading edge (324) and the side edge (325) converge.
38. Compressor (300) according to embodiment 37, wherein the pockets (200) are arranged in the axial direction (22) in such a way that a center of the opening (210), which lies halfway along the opening length (212), is situated approximately at the vertex (329).
39. Compressor (300) according to any one of embodiments 25 to 38, wherein the angle of attack (γ) is angled from the radial direction (24) in a rotation direction (ω) of the compressor wheel (320).
40. Charging apparatus (400) comprising:
   a drive unit (410) and a compressor (300) according to any one of the preceding embodiments, wherein the charging apparatus (400) comprises a shaft (420), via which the compressor (300) and the drive unit (410) are coupled to one another for conjoint rotation.
41. Charging apparatus (400) according to embodiment 40, wherein the drive unit (410) comprises a turbine and/or an electric motor.

1. Flow-modifying device (10) for a compressor (300) of a charging apparatus (400) comprising:
a cylindrical housing portion (150), which defines an inner lateral surface (152) and in the axial direction (22) comprises a downstream end region (154) and an upstream end region (156); and
a plurality of pockets (200), which are arranged on the inner lateral surface (152), spaced-apart from one another in the peripheral direction (26);
wherein each pocket (200) is defined by a longitudinal projection line (202) and a depth projection line (204),
wherein in an orientation plane (203), which is formed by the longitudinal projection line (202) and the depth projection line (204), a downstream angle of entry (α) of the pocket (200) relative to the inner lateral surface (152) defines a downstream opening region (214) of the pocket (200) and an upstream angle of entry (β) of the pocket (200) relative to the lateral inner surface (152) defines an upstream opening region (216) of the pocket (200), and
wherein the pocket (200) is formed here in such a way that: (β)<90°<(α).

2. Flow-modifying device (10) according to claim 1, wherein 10°<(β)<30°, preferably 15°<(β)<20° and particularly preferably 17°≤(β)≤19°.

3. Flow-modifying device (10) according to claim 1, wherein 120°<(α)<165°, preferably 130°<(α)<150° and particularly preferably 135°≤(α)≤145°

4. Flow-modifying device (10) according to claim 1, wherein the depth projection line (204) is inclined relative to the radial direction (24) by an angle of attack (γ), and optionally wherein 0°<(γ)<60°, preferably 15°<(γ)<50° and particularly preferably 35°≤(γ)≤45°.

5. Flow-modifying device (10) according to claim 1, wherein the pocket (200) comprises an opening (210) with an opening face (211).

6. Flow-modifying device (10) according to claim 1, wherein the pocket (200) comprises a length (208), an opening (210) with an opening length (212), and a depth (209), and wherein a contour (220) of the pocket (200) is determined by an entry point (222) at which the downstream angle of entry (α) is present, by an exit point (228) at which the upstream angle of entry (β) is present, and by a change point (224) between the entry point (222) and the exit point (228), and optionally wherein the contour (220) lies in the orientation plane (203).

7. Flow-modifying device (10) according to claim 6, wherein the entry point (222) is determined by a downstream point of intersection between the longitudinal projection line (202) and an opening contour (210a) of the opening (210), wherein the exit point (228) is determined by an upstream point of intersection between the longitudinal projection line (202) and the opening contour (210a), and wherein the change point (224) represents the deepest point of the contour (220) relative to the longitudinal projection line (202).

8. Flow-modifying device (10) according to claim 6, wherein a first contour portion (220a) with a variable angle (α′) is formed between the entry point (222) and the change point (224) and a second contour portion (220b) with a variable angle (β′) is formed between the change point (224) and the exit point (228), and optionally wherein (α′) changes from (α′)=(α) at the entry point (222) to (α′)=180° at the change point (224) in such a way that the profile of the first contour portion (220a) from the entry point (222) to the change point (224) does not have any sudden changes or kinks and (α′) at least does not become smaller.

9. Flow-modifying device (10) according to claim 8, wherein (β)′ changes from (β)′=180° at the change point (224) to (β)′=(β) at the exit point (228) in such a way that the profile of the second contour portion (220b) from the change point (224) to the outlet point (228) does not have any sudden changes or kinks and (β)′ at least does not become larger.

10. Compressor (300) for a charging apparatus (400) comprising:
a compressor housing (310), which defines a compressor inlet (312) with an inlet cross-section (312a) and a compressor outlet (314);
a compressor wheel (320), which is arranged between the compressor inlet (312) and the compressor outlet (314) so as to be rotatable in the compressor housing (310); and
a flow-modifying device (10) according to claim 1.

11. Compressor (300) according to claim 10, further comprising an adjustment mechanism (100) having a plurality of aperture elements (110) for changing the inlet cross-section (312a), and optionally
wherein the cylindrical housing portion (150) is arranged downstream of the aperture elements (110).

12. Compressor (300) according to claim 10, wherein the cylindrical housing portion (150) is manufactured integrally with the compressor housing (310) or is manufactured as a separate component.

13. Compressor (300) according to claim 10, wherein the cylindrical housing portion (150) is constructed in a number of parts and comprises a plurality of sub-portions (157) in the peripheral direction (26) and/or a plurality of sub-portions (159) in the axial direction (22).

14. Compressor (300) according to claim 10, wherein the cylindrical housing portion (150), if this is formed as a separate part, is insertable into the compressor housing (310) from the compressor inlet (312) in the axial direction (22) to the compressor outlet (314) or in the opposite axial direction (22).

15. Charging apparatus (400) comprising:
a drive unit (410) and a compressor (300) according to claim 10, wherein the charging apparatus (400) comprises a shaft (420), via which the compressor (300) and the drive unit (410) are coupled to one another for conjoint rotation.
